(19) United States
(12) Patent Application Publication
(10) Pub. No.: US 2025/0145745 A1
(43) Pub. Date: May 8, 2025

(54) HIGH MFR POLYPROPYLENE FOR MELTBLOWN NONWOVEN APPLICATIONS

(71) Applicant: W.R. Grace & Co.-CONN., Columbia, MD (US)

(72) Inventors: Lian Bai, Laurel, MD (US); Vivek Kalihari, Clarksville, MD (US); Jonathan Paul Reeds, Columbia, MD (US); Jan van Egmond, Charleston, WV (US)

(21) Appl. No.: 18/837,351

(22) PCT Filed: Feb. 10, 2023
(86) PCT No.: PCT/US2023/012835

§ 371 Date: Aug. 9, 2024

Related U.S. Application Data
(60) Provisional application No. 63/309,378, filed on Feb. 11, 2022.

(51) Int. Cl. C08F 110/06; D01D 5/08; D01F 6/06; D04H 3/007; D04H 3/16

(52) U.S. Cl. CPC C08F 110/06; D01D 5/08; D01F 6/06; D04H 3/007; D04H 3/16; D10B 2321/022

(57) ABSTRACT

A polymer composition including a polypropylene polymer having the following characteristics: exhibiting a melt flow rate of greater than about 900 g/10 min; a molecular weight distribution (M_{w}/Mₙ) of greater than about 4.5 or 6; a M_{z+1}/M_{w} ratio of less than about 8; and a xylene soluble content of less than about 4.0% by weight. Such polymers are useful in meltblown nonwoven applications.

### CROSS REFERENCE TO RELATED APPLICATIONS

This application claims the benefit of priority to U.S. Provisional Patent Application No. 63/309,378 filed Feb. 11, 2022, which is hereby incorporated by reference, in its entirety for any and all purposes.

### FIELD

The present technology is generally related to polyolefin polymers, such as polypropylene polymers. More specifically, the technology is related high melt flow rate (MFR) polypropylene polymers that are useful for meltblown nonwoven applications.

### BACKGROUND

Polyolefin polymers are used in numerous and diverse applications and fields. Polyolefin polymers, for instance, are thermoplastic polymers that can be easily processed. The polyolefin polymers can also be recycled and reused. Polyolefin polymers are formed from hydrocarbons, such as ethylene and alpha-olefins, which are obtained from petrochemicals and are abundantly available.

Polypropylene polymers, which are one type of polyolefin polymer, generally have a linear structure based on a propylene monomer. Polypropylene polymers can have various different stereospecific configurations. Polypropylene polymers, for example, can be isotactic, syndiotactic, and atactic. Isotactic polypropylene is perhaps the most common form and can be highly crystalline. Polypropylene polymers that can be produced include homopolymers, modified polypropylene polymers, and polypropylene copolymers that include polypropylene terpolymers. By modifying the polypropylene or copolymerizing the propylene with other monomers, various different polymers can be produced having desired properties for a particular application.

Currently, there is a particular demand and need for polypropylene polymers having a very high melt flow rate. The melt flow rate of a polymer generally indicates the amount of molten polymer that flows over a period of time at a particular temperature and load. Higher melt flow rates can indicate that the polymer can be easily processed, especially during extrusion, injection molding, and during the formation of fibers and films. High melt flow rate polypropylene polymers are particularly well suited to producing meltblown webs. Meltblown nonwoven webs are generally formed from a molten thermoplastic polymer that is extruded through a plurality of fine, usually circular, dye capillaries as molten fibers. As the fibers are formed, the fibers contact a high velocity gas, such as air, that attenuates the fibers to reduce their diameter. The meltblown fibers are then deposited onto a collecting surface that forms a web of randomly dispersed meltblown fibers. The meltblown fibers can be continuous or discontinuous. Meltblown webs are particularly well suited for use in filtration applications.

For example, meltblown webs can be incorporated into facemasks that are designed to cover the nose and mouth of the wearer. When incorporated into a facemask, meltblown webs are well suited to protecting the wearer by preventing the passage of microorganisms, such as viruses, and other contaminants. Due to the coronavirus pandemic, facemasks are now being worn not only by medical professionals, but also by office workers, industrial workers, students, and consumers in virtually all public places.

In the past, in order to produce polypropylene polymers having high melt flow rates for use in producing meltblown webs, the polymers were formed using a metallocene catalyst, or alternatively, the polymer was subjected to peroxide cracking. When using a metallocene catalyst, which are also referred to as single site catalysts, the polymerization process can be relatively slow and somewhat inefficient in that the raw material utilization is low. Further, transitioning the equipment between the use of a Ziegler-Natta catalyst and a metallocene catalyst to produce the polymers can be time consuming and expensive. In addition, metallocene catalyst can be susceptible to reactor operability problems and are not compatible with any known activity limiting agents. Metallocene catalysts can also be sensitive to raw material impurities.

Peroxide cracking technology to produce high melt flow high rate polypropylene polymers also has various drawbacks. Peroxide, for instance, can be expensive. Further, peroxide feed during the process must be carefully controlled so that enough peroxide is fed to achieve stable production of the high melt flow rate polymer. In addition, unreacted peroxide can remain in the final material that causes degradation over time leading to taste, odor, and volatile components that are undesirable. Finally, peroxide cracking can result in unwanted volatiles that may need to be removed through a thermal oxidation process in order to comply with environmental regulations.

In view of the above, a need currently exists for a more efficient process for producing high melt flow rate polypropylene polymers. A need also exists for polypropylene polymer compositions containing a high melt flow rate polypropylene polymer that can be used to produce all different types of articles including meltblown webs.

The high melt flow rate polypropylene polymers described herein may have the following advantages in the context of multilayer spun-melt-spun (SMS) fabrics. Compared with reactor grade melt blown polypropylene polymers produced with metallocene catalyst, the reactor grade ultra-high MFR polypropylene polymers described herein, which are produced with Ziegler-Natta catalysts, could give a broader operation temperature window in the multilayer spunbound-meltblown-spunbound (SMS) fabrics (SBNW-MB-SBNW layers; SBNW=spunbound nonwoven and MB=meltblown) calendaring/bonding step. Because most of the SBNW layers are produced with cracked grade Ziegler-Natta catalyst-based polypropylene polymers, the reactor grade polypropylene polymers for meltblown (MB) application in this invention have broader molecular weight distribution (MWD) than the metallocene polypropylene polymers counterparts, which contributes to the broader bonding temperature window.

### SUMMARY

The present disclosure is generally directed to a process for producing high melt flow rate polyolefin polymers, and to the polymers produced by the process. The high melt flow rate polyolefin polymers can be used in numerous and diverse applications. For example, the high melt flow rate polypropylene polymers described herein, which are prepared with Ziegler-Natta catalysts, have a broader molecular weight distribution than polypropylene polymers prepared from using metallocene catalysts. This is particularly useful for producing multilayer spunbound-meltblown-spunbound (SMS) fabrics, wherein the meltblown layer includes the high melt flow rate polypropylene polymers described herein and as a result provides a broader operation temperature window in the bonding step.

Provided in one aspect is a polymer composition including a polypropylene polymer having the following characteristics: exhibiting a melt flow rate of greater than about 900 g/10 min; having a molecular weight distribution (M_{w}/Mₙ) of greater than about 4.5 or 6; having a M_{z+1}/M_{w} ratio of less than about 8; and having a xylene soluble content of less than about 4.0% by weight.

In some embodiments, the polypropylene polymer exhibits a melt flow rate of greater than about 1300 g/10 min. In some embodiments, the polypropylene polymer exhibits a melt flow rate of from about 1300 g/10 min to about 4000 g/10 min.

In some embodiments, the polypropylene polymer has an M_{w}/Mₙ of greater than about 6. In some embodiments, the polypropylene polymer has an M_{w}/Mₙ of greater than about 7. In some embodiments, the polypropylene polymer has an M_{w}/Mₙ of from about 6.0 to about 10.0.

In some embodiments, the polypropylene polymer has an M_{z+1}/M_{w} ratio of less than about 7. In some embodiments, the polypropylene polymer has an M_{z+1}/M_{w} ratio of from about 6.0 to about 8.0.

In some embodiments, the polypropylene polymer has a xylene soluble content of from about 1.5% by weight to about 4% by weight. In some embodiments, the polypropylene polymer exhibits a melting temperature of greater than about 155° C. In some embodiments, the polypropylene polymer exhibits a melting temperature of from about 155° C. to about 168° C.

In some embodiments, the polypropylene polymer has a weight averaged molecular weight of less than about 80,000 g/mol. In some embodiments, the polypropylene polymer has a weight averaged molecular weight of from about 55,000 to about 70,000 g/mol, as measured by gel permeation chromatography (GPC).

In some embodiments, the polypropylene polymer has a number averaged molecular weight of less than about 8,500 g/mol. In some embodiments, the polypropylene polymer has a number averaged molecular weight of from about 7,000 to about 8,000 g/mol.

In some embodiments, the polypropylene polymer is a polypropylene homopolymer. In some embodiments, the polypropylene polymer has been Ziegler-Natta catalyzed. In some embodiments, the polypropylene polymer has been catalyzed in the presence of a Ziegler-Natta catalyst including an internal electron donor, the internal electron donor including a substituted phenylene diester or a phthalate compound.

In some embodiments, the polypropylene polymer includes a processing aid combined with at least one other polymer exhibiting a lower melt flow rate, the polypropylene polymer being contained in the composition in an amount less than about 50% by weight. In some embodiments, the polypropylene polymer includes a wax, a lubricant, a mold release agent, or a flow aid.

In some embodiments, the polypropylene polymer has been catalyzed in the presence of a Ziegler-Natta catalyst, the Ziegler-Natta catalyst including a solid catalyst component, a selectively control agent, and optionally an activity limiting agent, the solid catalyst component including a magnesium moiety, a titanium moiety, and an internal electron donor. In some embodiments, the solid catalyst component further includes an organosilicon compound and an epoxy compound. In some embodiments, the selectively control agent includes an organosilicon compound. In some embodiments, the selectively control agent includes propyltriethoxysilane, diisobutyldimethoxysilane, n-propyltrimethoxysilane, or mixtures thereof and is used in combination with an activity limiting agent.

In some embodiments, the polypropylene polymer does not include any peroxides. In some embodiments, the composition is suitable for meltblown nonwoven applications.

Provided in one aspect is a meltblown web comprised of nonwoven, meltblown fibers, the meltblown fibers being made from any one of the polymer compositions described herein.

Provided in one aspect is a meltblown fiber made from any one of the polymer compositions described herein, the meltblown fiber having a diameter of less than about 5 microns.

In some embodiments, the meltblown fiber has a diameter of less than about 3 microns. In some embodiments, the meltblown fiber has a diameter of from about 1.5 to about 3.0 microns.

Provided in one aspect is a nonwoven web including a multi-layer structure including: one or more meltblown layers including any one of the meltblown fibers described herein.

In some embodiments, the nonwoven web includes one meltblown layer. In some embodiments, the nonwoven web includes two or more meltblown layers. In some embodiments, the two or more meltblown layers include the same meltblown layers. In some embodiments, the two or more meltblown layers include the different meltblown layers.

In some embodiments, the nonwoven web further includes two or more spunbound layers including a spunbound fiber. In some embodiments, spunbound fiber is prepared from a polymer composition including a polypropylene polymer having one or more of the following characteristics: exhibiting a melt flow rate of from about 20 g/10 min to about 70 g/10 min; having a molecular weight distribution (M_{w}/Mₙ) of less than about 4; and having a xylene soluble content of from about 1.5% by weight to about 4% by weight.

In some embodiments, the polypropylene polymer has an M_{w}/Mₙ of from about 3.0 to about 4.0. In some embodiments, the polypropylene polymer has a weight averaged molecular weight of less than about 300,000 g/mol. In some embodiments, the polypropylene polymer has a weight averaged molecular weight of from about 150,000 to about 250,000 g/mol. In some embodiments, the polypropylene polymer has a number averaged molecular weight of less than about 60,000 g/mol. In some embodiments, the polypropylene polymer has a number averaged molecular weight of from about 40,000 to about 55,000 g/mol. In some embodiments, the polypropylene polymer exhibiting a melting temperature greater than 155° C. In some embodiments, the polypropylene polymer may be produced with a metallocene catalyst and exhibit a melting temperature of about 155° C. or less.

In some embodiments, the nonwoven web comprises two or more spunblown layers. In some embodiments, the two or more spunblown layers comprise the same spunblown layers. In some embodiments, the two or more spunblown layers comprise the different spunblown layers.

In some embodiments, the nonwoven web has a multilayer structure comprising a first spunbound layer, a meltblown layer, and a second spunbound layer. In some embodiments, the first spunbound layer and the second spunbound layer are the same. In some embodiments, the first spunbound layer and the second spunbound layer are different.

In some embodiments, the nonwoven web has an air permeability of less than about 100/m²/sec. In some embodiments, the nonwoven web has an air permeability of from about 40 to about 80 l/m²/sec. In some embodiments, the nonwoven web has a machine direction (MD) tensile strength from about 2500 g/inch to about 3500 g/inch.

Provided in another aspect is a process for producing any one of the nonwoven webs disclosed herein including: contacting one or more meltblown layers with two or more spunbound layers at a bonding temperature of from about 130° C. to about 140° C.

In some embodiments, the bonding temperature is about 135° C.

Provided in one aspect is a process for producing a polypropylene polymer including: polymerizing a propylene monomer in the presence of a Ziegler-Natta catalyst, the Ziegler-Natta catalyst including a solid catalyst component, a selectively control agent, and optionally an activity limiting agent, the solid catalyst component including a magnesium moiety, a titanium moiety and an internal electron donor, the selectively control agent including an organosilicon compound, and wherein a polypropylene polymer is formed exhibiting a melt flow rate of greater than about 900 g/10 min, and wherein no peroxides are used during the process to form the polypropylene polymer.

In some embodiments, the solid catalyst component further includes an organosilicon compound and an epoxy compound. In some embodiments, the internal electron donor includes a substituted phenylene diester or a phthalate compound. In some embodiments, the selectively control agent includes an organosilicon compound, and wherein a polypropylene polymer is formed exhibiting a melt flow rate of greater than about 1000 g/10 min.

In some embodiments, an H2/C3 molar ratio during polymerization is between about 0.1 and about 0.3. In some embodiments, a cocatalyst and the external electron donor are fed to the polymerization reactor at a molar ratio of about 1.5 to about 15. In some embodiments, a reactor temperature during polymerization is between about 65° C. and about 95° C. In some embodiments, the temperature is increased in order to increase the melt flow rate. In some embodiments, the propylene partial pressure is reduced in order to increase the melt flow rate of the polypropylene polymer.

### BRIEF DESCRIPTION OF THE DRAWINGS

FIG. 1 is a perspective view of a facemask that may be made from the polymer composition of the present disclosure.

FIG. 2 is a graphical representation of some of the results obtained in the examples below and illustrates the relationship between melt flow rate and H2/C3 molar ratio.

FIG. 3 is a graphical representation of some of the results obtained in the examples below and illustrates the relationship between melt flow rate and xylene solubles; and

FIG. 4 is a graphical representation of some of the results obtained in the examples below and illustrates the relationship between fines and melt flow rate.

FIG. 5 is a depiction of the tensile test template used in the machine direction (MD) tensile strength test as described in the Examples.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and may be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. An alkyl group may be substituted one or more times. An alkyl group may be substituted two or more times. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, isopentyl groups, and 1-cyclopentyl-4-methylpentyl. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl”, or “aromatic,” groups are cyclic aromatic hydrocarbons that do not contain heteroatoms. Aryl groups include monocyclic, bicyclic, and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. An aryl group with one or more alkyl groups may also be referred to as alkaryl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

Heterocyclyl or heterocycle refers to both aromatic and nonaromatic ring compounds including monocyclic, bicyclic, and polycyclic ring compounds containing 3 or more ring members of which one or more is a heteroatom such as, but not limited to, N, O, and S. Examples of heterocyclyl groups include, but are not limited to: unsaturated 3 to 8 membered rings containing 1 to 4 nitrogen atoms such as, but not limited to pyrrolyl, pyrrolinyl, imidazolyl, pyrazolyl, pyridinyl, dihydropyridinyl, pyrimidinyl, pyrazinyl, pyridazinyl, triazolyl (e.g. 4H-1,2,4-triazolyl, 1H-1,2,3-triazolyl, 2H-1,2,3-triazolyl etc.), tetrazolyl, (e.g. 1H-tetrazolyl, 2H tetrazolyl, etc.); saturated 3 to 8 membered rings containing 1 to 4 nitrogen atoms such as, but not limited to, pyrrolidinyl, imidazolidinyl, piperidinyl, piperazinyl; condensed unsaturated heterocyclic groups containing 1 to 4 nitrogen atoms such as, but not limited to, indolyl, isoindolyl, indolinyl, indolizinyl, benzimidazolyl, quinolyl, isoquinolyl, indazolyl, benzotriazolyl; unsaturated 3 to 8 membered rings containing 1 to 2 oxygen atoms and 1 to 3 nitrogen atoms such as, but not limited to, oxazolyl, isoxazolyl, oxadiazolyl (e.g. 1,2,4-oxadiazolyl, 1,3,4-oxadiazolyl, 1,2,5-oxadiazolyl, etc.); saturated 3 to 8 membered rings containing 1 to 2 oxygen atoms and 1 to 3 nitrogen atoms such as, but not limited to, morpholinyl; unsaturated condensed heterocyclic groups containing 1 to 2 oxygen atoms and 1 to 3 nitrogen atoms, for example, benzoxazolyl, benzoxadiazolyl, benzoxazinyl (e.g. 2H-1,4-benzoxazinyl etc.); unsaturated 3 to 8 membered rings containing 1 to 3 sulfur atoms and 1 to 3 nitrogen atoms such as, but not limited to, thiazolyl, isothiazolyl, thiadiazolyl (e.g. 1,2,3-thiadiazolyl, 1,2,4-thiadiazolyl, 1,3,4-thiadiazolyl, 1,2,5-thiadiazolyl, etc.); saturated 3 to 8 membered rings containing 1 to 2 sulfur atoms and 1 to 3 nitrogen atoms such as, but not limited to, thiazolodinyl; saturated and unsaturated 3 to 8 membered rings containing 1 to 2 sulfur atoms such as, but not limited to, thienyl, dihydrodithiinyl, dihydrodithionyl, tetrahydrothiophene, tetrahydrothiopyran; unsaturated condensed heterocyclic rings containing 1 to 2 sulfur atoms and 1 to 3 nitrogen atoms such as, but not limited to, benzothiazolyl, benzothiadiazolyl, benzothiazinyl (e.g. 2H-1,4-benzothiazinyl, etc.), dihydrobenzothiazinyl (e.g. 2H-3,4-dihydrobenzothiazinyl, etc.), unsaturated 3 to 8 membered rings containing oxygen atoms such as, but not limited to furyl; unsaturated condensed heterocyclic rings containing 1 to 2 oxygen atoms such as benzodioxolyl (e.g., 1,3-benzodioxoyl, etc.); unsaturated 3 to 8 membered rings containing an oxygen atom and 1 to 2 sulfur atoms such as, but not limited to, dihydrooxathiinyl; saturated 3 to 8 membered rings containing 1 to 2 oxygen atoms and 1 to 2 sulfur atoms such as 1,4-oxathiane; unsaturated condensed rings containing 1 to 2 sulfur atoms such as benzothienyl, benzodithiinyl; and unsaturated condensed heterocyclic rings containing an oxygen atom and 1 to 2 oxygen atoms such as benzoxathiinyl. Heterocyclyl group also include those described above in which one or more S atoms in the ring is double-bonded to one or two oxygen atoms (sulfoxides and sulfones). For example, heterocyclyl groups include tetrahydrothiophene oxide and tetrahydrothiophene 1,1-dioxide. Typical heterocyclyl groups contain 5 or 6 ring members. Thus, for example, heterocyclyl groups include morpholinyl, piperazinyl, piperidinyl, pyrrolidinyl, imidazolyl, pyrazolyl, 1,2,3-triazolyl, 1,2,4-triazolyl, tetrazolyl, thiophenyl, thiomorpholinyl, thiomorpholinyl in which the S atom of the thiomorpholinyl is bonded to one or more O atoms, pyrrolyl, pyridinyl homopiperazinyl, oxazolidin-2-onyl, pyrrolidin-2-onyl, oxazolyl, quinuclidinyl, thiazolyl, isoxazolyl, furanyl, dibenzylfuranyl, and tetrahydrofuranyl. Heterocyclyl or heterocycles may be substituted.

Heteroaryl groups are aromatic ring compounds containing 5 or more ring members, of which, one or more is a heteroatom such as, but not limited to, N, O, and S. Heteroaryl groups include, but are not limited to, groups such as pyrrolyl, pyrazolyl, triazolyl, tetrazolyl, oxazolyl, isoxazolyl, thiazolyl, pyridinyl, pyridazinyl, pyrimidinyl, pyrazinyl, thiophenyl, benzothiophenyl, furanyl, benzofuranyl, dibenzofuranyl, indolyl, azaindolyl (pyrrolopyridinyl), indazolyl, benzimidazolyl, imidazopyridinyl (azabenzimidazolyl), pyrazolopyridinyl, triazolopyridinyl, benzotriazolyl, benzoxazolyl, benzothiazolyl, benzothiadiazolyl, imidazopyridinyl, isoxazolopyridinyl, thianaphthyl, purinyl, xanthinyl, adeninyl, guaninyl, quinolinyl, isoquinolinyl, tetrahydroquinolinyl, quinoxalinyl, and quinazolinyl groups. Heteroaryl groups include fused ring compounds in which all rings are aromatic such as indolyl groups and include fused ring compounds in which only one of the rings is aromatic, such as 2,3-dihydro indolyl groups. Although the phrase “heteroaryl groups” includes fused ring compounds, the phrase does not include heteroaryl groups that have other groups bonded to one of the ring members, such as alkyl groups. Rather, heteroaryl groups with such substitution are referred to as “substituted heteroaryl groups.” Representative substituted heteroaryl groups may be substituted one or more times with various substituents such as those listed above.

As used herein, the prefix “halo” refers to a halogen (i.e. F, Cl, Br, or I) being attached to the group being modified by the “halo” prefix. For example, haloaryls are halogenated aryl groups.

Groups described herein having two or more points of attachment (i.e., divalent, trivalent, or polyvalent) within the compound of the present technology are designated by use of the suffix, “ene.” For example, divalent alkyl groups are alkylene groups, divalent aryl groups are arylene groups, divalent heteroaryl groups are divalent heteroarylene groups, and so forth.

### Testing Procedures

Melt flow rate (MFR), as used herein, is measured in accordance with the ASTM D1238 test method at 230° C. with a 2.16 kg weight for propylene-based polymers. The melt flow rate can be measured in pellet form or on the reactor powder. When measuring the reactor powder, a stabilizing package can be added including 2000 ppm of CYANOX 2246 antioxidant (methylenebis(4-methyl-6-tert-butylphenol) 2000 ppm of IRGAFOS 168 antioxidant (tris(2,4-di-tert.-butylphenyl)phosphite) and 1000 ppm of acid scavenger ZnO.

For high melt flow rate polymers, the testing die orifice may be smaller as indicated below:

| | |
|---|---|
| Equipment | Tungsten carbide large orifice 2.0955 ± |
| | 0.0051 mm (0.0825 ± 0.0002″) I.D. × |
| | 8.000 ± 0.025 mm (0.315 ± 0.001″) |
| | long |
| | Tungsten carbide small orifice 1.0490 ± |
| | 0.0051 mm (0.0413 ± 0.0002″) I.D. × |
| | 4.000 ± 0.025 mm (0.1575 ± 0.001″) |
| | long |
| | Position the piston and die in the cylinder and seat firmly on |
| | the base plate. Maintain the temperature for at least 15 |
| | minutes before beginning a test. When equipment is used |
| | repetitiously, it should not be necessary to heat the piston and |
| | die for 15 min. |
| | For Polypropylene materials having a melt index greater than |
| | 50, the small orifice is used. |

### Calculations for Polypropylene Polymers:

| Step | Action |
|---|---|
| 1 | $1 / 4 inch timing interval with large die , Melt Flow = \frac{200}{TestTime}$ |
| 2 | $One inch timing interval with large die , Melt Flow = \frac{800}{TestTime}$ |
| 3 | $1 / 4 inch timing interval with small die , Melt Flow = \frac{1600}{TestTime}$ |
| 4 | $One inch timing interval with small die , Melt Flow = \frac{6400}{TestTime}$ |

Particle size can be measured using a sieve test. The sieve test is conducted on a GRADEX Particle Size Analyzer commercially available from Rotex Global. Average particle size based on weight fractions is determined from the particle size distribution obtained from the GRADEX Particle Size Analyzer.

Fines is defined as the weight fraction of polymer particles that pass through the GRADEX 120 mesh (125 microns).

Xylene solubles (XS) is defined as the weight percent of resin that remains in solution after a sample of polypropylene random copolymer resin is dissolved in hot xylene and the solution is allowed to cool to 25° C. This is also referred to as the gravimetric XS method according to ASTM D5492-06 using a 60 minute precipitation time and is also referred to herein as the “wet method”.

The ASTM D5492-06 method mentioned above may be adapted, as described below, to determine the xylene soluble portion. In general, the procedure consists of weighing 2 g of sample and dissolving the sample in 200 ml o-xylene in a 400 ml flask with 24/40 joint. The flask is connected to a water-cooled condenser and the contents are stirred and heated to reflux under nitrogen (N2), and then maintained at reflux for an additional 30 minutes. The solution is then cooled in a temperature controlled water bath at 25° C. for 60 minutes to allow the crystallization of the xylene insoluble fraction. Once the solution is cooled and the insoluble fraction precipitates from the solution, the separation of the xylene soluble portion (XS) from the xylene insoluble portion (XI) is achieved by filtering through 25 micron filter paper. One hundred ml of the filtrate is collected into a pre-weighed aluminum pan, and the o-xylene is evaporated from this 100 ml of filtrate under a nitrogen stream. Once the solvent is evaporated, the pan and contents are placed in a 100° C. vacuum oven for 30 minutes or until dry. The pan is then allowed to cool to room temperature and weighed. The xylene soluble portion is calculated as XS (wt %)=[(m3−m2)*2/m1]*100, where m1 is the original weight of the sample used, m2 is the weight of empty aluminum pan, and m3 is the weight of the pan and residue (the asterisk, *, here and elsewhere in the disclosure indicates that the identified terms or values are multiplied).

XS can also be measured according to the Viscotek method, as follows: 0.4 g of polymer is dissolved in 20 ml of xylenes with stirring at 130° C. for 60 minutes. The solution is then cooled to 25° C. and after 60 minutes the insoluble polymer fraction is filtered off using a 0.2 μm syringe filter. The resulting filtrate is analyzed by Flow Injection Polymer Analysis using a Viscotek ViscoGEL H-100-3078 column with THF mobile phase flowing at 1.0 ml/min. The column is coupled to a Viscotek Model 302 Triple Detector Array, with light scattering, viscometer and refractometer detectors operating at 45° C. Instrument calibration is maintained with Viscotek PolyCAL™ polystyrene standards. A polypropylene (PP) homopolymer, such as biaxially oriented polypropylene (BOPP) grade Dow 5D98, is used as a reference material to ensure that the Viscotek instrument and sample preparation procedures provide consistent results. The value for the reference polypropylene homopolymer, such as 5D98, is initially derived from testing using the ASTM method identified above.

The weight average molecular weight (Mw), the number average molecular weight (Mn), the molecular weight distribution (M_{w}/Mₙ) (also referred to as “MWD”) and higher average molecular weights (Mz and Mz+1) are measured by GPC according to the Gel Permeation Chromatography (GPC) Analytical Method for Polypropylene. The polymers are analyzed on Polymer Char High Temperature GPC with IR5 MCT (Mercury Cadmium Telluride-high sensitivity, thermoelectrically cooled IR detector), Polymer Char four capillary viscometer, a Wyatt 8 angle MALLS and three Agilent Pigel Olexis (13 um). The oven temperature is set at 150° C. The solvent is nitrogen purged 1,2,4-trichlorobenzene (TCB) containing ^{˜}200 ppm 2,6-di-t-butyl-4-methylphenol (BHT). The flow rate is 1.0 mL/min and the injection volume was 200 μl. A 2 mg/mL sample concentration is prepared by dissolving the sample in N2 purged and preheated TCB (containing 200 ppm BHT) for 2 hours at 160° C. with gentle agitation.

The GPC column set is calibrated by running twenty narrow molecular weight distribution polystyrene standards. The molecular weight (MW) of the standards ranges from 266 to 12,000,000 g/mol, and the standards were contained in 6 “cocktail” mixtures. Each standard mixture has at least a decade of separation between individual molecular weights. The polystyrene standards are prepared at 0.005 g in 20 mL of solvent for molecular weights equal to or greater than 1,000,000 g/mol and 0.001 g in 20 mL of solvent for molecular weights less than 1,000,000 g/mol. The polystyrene standards are dissolved at 160° C. for 60 min under stirring. The narrow standards mixtures are run first and in order of decreasing highest molecular weight component to minimize degradation effect. A logarithmic molecular weight calibration is generated using a fourth-order polynomial fit as a function of elution volume. The equivalent polypropylene molecular weights are calculated by using following equation with reported Mark-Houwink coefficients for polypropylene (Th. G. Scholte, N. L. J. Meijerink, H. M. Schoffeleers, and A. M. G. Brands, J. Appl. Polym. Sci., 29, 3763-3782 (1984)) and polystyrene (E. P. Otocka, R. J. Roe, N. Y. Hellman, P. M. Muglia, Macromolecules, 4, 507 (1971)):

$${M}_{PP} = {( \frac{{K}_{PS} {M}_{PS}^{\text{?} PS + 1}}{{K}_{PP}} )}^{\frac{1}{α pp + 1}}$$

$$\text{?} \text{indicates text missing or illegible when filed}$$

where Mpp is PP equivalent MW, MPS is PS equivalent MW, log K and a values of Mark-Houwink coefficients for PP and PS are listed below (the GPC data was processed using a procedure adapted from ISO 16014-1 with the lower integration limit placed at 3500 daltons to exclude inference from additives).

TABLE 2

| Polymer | A | Log K |
|---|---|---|
| Polypropylene | 0.725 | −3.721 |
| Polystyrene | 0.702 | −3.900 |

The melting point or melting temperature and the crystallization temperature are determined using differential scanning calorimetry (DSC). The term “crystallinity” refers to the regularity of the arrangement of atoms or molecules forming a crystal structure. Polymer crystallinity can be examined using DSC. Tₘₑ means the temperature at which the melting ends and Tₘₐₓ means the peak melting temperature, both as determined by one of ordinary skill in the art from DSC analysis using data from the final heating step. One suitable method for DSC analysis uses a model Q1000™ DSC from TA Instruments, Inc. Calibration of the DSC is performed in the following manner. First, a baseline is obtained by heating the cell from −90° C. to 290° C. without any sample in the aluminum DSC pan. Then 7 milligrams of a fresh indium sample is analyzed by heating the sample to 180° C., cooling the sample to 140° C. at a cooling rate of 10° C./min followed by keeping the sample isothermally at 140° C. for 1 minute, followed by heating the sample from 140° C. to 180° C. at a heating rate of 10° C./min. The heat of fusion and the onset of melting of the indium sample are determined and checked to be within 0.5° C. from 156.6° C. for the onset of melting and within 0.5 J/g from 28.71 J/g for the heat of fusion. Then deionized water is analyzed by cooling a small drop of fresh sample in the DSC pan from 25° C. to −30° C. at a cooling rate of 10° C./min. The sample is kept isothermally at −30° C. for 2 minutes and heated to 30° C. at a heating rate of 10° C./min. The onset of melting is determined and checked to be within 0.5° C. from 0° C.

One method of determining crystallinity in the high crystalline polypropylene polymer is by differential scanning calorimetry (DSC). A small sample (milligram size) of the propylene polymer is sealed into an aluminum DSC pan. The sample is placed into a DSC cell with a 25 centimeter per minute nitrogen purge and cooled to about −80° C. A standard thermal history is established for the sample by heating at 10° C. per minute to 225° C. The sample is then cooled to about −80° C. and reheated at 10° C. per minute to 225° C. The observed heat of fusion (ΔH_{observed}) for the second scan is recorded. The observed heat of fusion is related to the degree of crystallinity in weight percent based on the weight of the polypropylene sample by the following equation:

$$Crystallinity \% = \frac{Δ {H}_{observed}}{Δ {H}_{isotactic} PP} \times 100$$

where the heat of fusion for isotactic polypropylene (ΔH_{isotactic PP}), as reported in B. Wunderlich, Macromolecular Physics, Volume 3, Crystal Melting, Academic Press, New Your, 1980, p 48, is 164.92 Joules per gram (J/g) of polymer.

Alternatively, crystallinity may also be determined using a heat of crystallization upon heating (HCH) method. In a HCH method, a sample is equilibrated at 200° C. and held at the temperature for three minutes. After the isothermal step, data storage is turned on, and the sample is ramped to −80° C. at 10° C. per minute. When −80° C. is reached, the data sampling is turned off, and the sample is held at the temperature for three minutes. After the second isothermal step, the data storage is turned on and the sample is ramped to 200° C. at 10° C. per minute.

The average fiber diameters may be determined by taking the average of 50 measurements from five SEM images in different locations on the fabrics. The SEM images are collected on the Tabletop Microscope TM3030Plus (HITACHI). The imaging conditions are listed in the following: Observation condition is under 5 kV voltage with standard observation mode, and the image signal is collected from secondary electrons. All the images are collected under the magnification of ×2500.

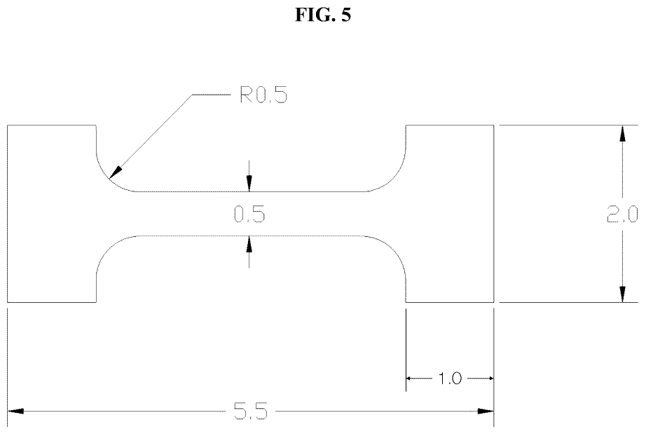

The tensile strength of the SMS nonwoven fabrics described herein may be determined by the following test method. The SMS fabrics are cut in the tensile test template as shown in FIG. 5 (unit in inch), and the length direction is the machine direction (MD) of the fabric. The tensile test is run on the Check-Line Test Stand (Model: FGS-50PVL) at room temperature (23° C.). During the test, the rate of extension is set at 100 mm/min, and the max. breaking strength (the peak tension in grams) is recorded as the “MD tensile strength”, and the break elongation is recorded as the “MD elongation”.

The air permeability of the SMS nonwoven fabrics described herein is determined by the NWSP 70.1 method, where the differential pressure is set at 200 Pa, and the fabric is cut into a circle with area of 20 cm\hat{ }2. The testing is taken at 23° C. with 50% RH.

### Polypropylene Polymers

Described herein are polyolefin polymers, such as polypropylene polymers (e.g., homopolymers), having a very high melt flow rate (MFR). These ultra-high MFR polypropylene polymers are prepared with Ziegler-Natta catalysts and under peroxide free conditions. Such high melt flow rate polypropylene polymers are particularly well suited for producing meltblown webs and for nonwoven applications.

The polypropylene polymers described herein may have one or more of the following advantages over polypropylene polymers produced by peroxide cracking technology: are less odorous; do not contain harmful volatiles (e.g. butanol) that result from the decomposition of peroxide by-products (e.g. Trigonox 101); and have less MFR variations due to the absence of residual peroxide. Furthermore, the polypropylene polymers described herein are also suitable for the preparation of multilayer spunbound-meltblown-spunbound (SMS) fabrics, wherein the meltblown layer is prepared from the meltblown fibers including the ultra-high MFR polypropylene polymers described herein.

Provided in one aspect is a polymer composition including a polypropylene polymer having the following characteristics:
exhibiting a melt flow rate of greater than about 900 g/10 min;
having a molecular weight distribution (M_{w}/Mₙ) of greater than about 4.5 or 6;
having a M_{z+1}/M_{w} ratio of less than about 8; and
having a xylene soluble content of less than about 4.0% by weight.

In general, the present disclosure is directed to a process for producing high melt flow rate polyolefin polymers, particularly polypropylene polymers including polypropylene homopolymers, polypropylene random copolymers and polypropylene block copolymers. Through the process of the present disclosure, polypropylene polymers can be produced having melt flow rates of greater than about 900 g/10 min, such as greater than about 1200 g/10 min, such as greater than about 1500 g/10 min, such as greater than about 1800 g/10 min, such as greater than about 2200 g/10 min, and such as greater than about 4000 g/10 min, without having to use a single site catalyst and/or without having to use any peroxides. The polypropylene polymers may exhibit a melt flow rate of greater than about 1300 g/10 min, such as greater than about 1400 g/10 min, greater than about 1500 g/10 min, greater than about 1600 g/10 min, greater than about 1700 g/10 min, greater than about 1800 g/10 min, greater than about 1900 g/10 min, greater than about 2000 g/10 min, greater than about 2100 g/10 min, greater than about 2200 g/10 min, greater than about 2300 g/10 min, greater than about 2400 g/10 min, greater than about 2500 g/10 min, greater than about 2600 g/10 min, greater than about 2700 g/10 min, greater than about 2800 g/10 min, greater than about 2900 g/10 min, greater than about 3000 g/10 min, greater than about 3100 g/10 min, greater than about 3200 g/10 min, greater than about 3300 g/10 min, greater than about 3400 g/10 min, greater than about 3500 g/10 min, greater than about 3600 g/10 min, greater than about 3700 g/10 min, greater than about 3800 g/10 min, greater than about 3900 g/10 min, and greater than about 4000 g/10 min. In some embodiments, the polypropylene polymer exhibits a melt flow rate of from about 1300 g/10 min to about 2200 g/10 min, including about 1300 g/10 min, about 1400 g/10 min, about 1500 g/10 min, about 1600 g/10 min, about 1700 g/10 min, about 1800 g/10 min, about 1900 g/10 min, about 2000 g/10 min, about 2100 g/10 min, about 2200 g/10 min, about 2300 g/10 min, about 2400 g/10 min, about 2500 g/10 min, about 2600 g/10 min, about 2700 g/10 min, about 2800 g/10 min, about 2900 g/10 min, about 3000 g/10 min, about 3100 g/10 min, about 3200 g/10 min, about 3300 g/10 min, about 3400 g/10 min, about 3500 g/10 min, about 3600 g/10 min, about 3700 g/10 min, about 3800 g/10 min, about 3900 g/10 min, and about 4000 g/10 min. The melt flow rate can be up to about 7000 g/10 min. Thus, the process of the present disclosure allows for the production of very high melt flow rate polypropylene polymers in a very efficient manner. The present disclosure is also directed to the polyolefin polymers made from the process.

The polypropylene polymer of the present disclosure, which can be a polypropylene homopolymer, is produced using a Ziegler-Natta catalyst. The catalyst generally includes a solid catalyst component in combination with a selectively control agent. Optionally, the catalyst can also include an activity limiting agent. The catalyst is activated during polymerization using a cocatalyst. The solid catalyst component can vary depending upon the particular application. In some embodiments, the polypropylene polymer has been catalyzed in the presence of a Ziegler-Natta catalyst, the Ziegler-Natta catalyst including a solid catalyst component, a selectively control agent, and optionally an activity limiting agent, the solid catalyst component including a magnesium moiety, a titanium moiety, and an internal electron donor. In general, the solid catalyst component contains a magnesium moiety, a titanium moiety, and an internal electron donor. In one aspect, the solid catalyst component can optionally include an organic phosphorous compound, an organosilicon compound, and an epoxy compound. In some embodiments, the solid catalyst component further includes an organosilicon compound and an epoxy compound. In some embodiments, the internal electron donor includes an aryl diester, a diether, a succinate, an organic acid ester, a polycarboxylic acid ester, a polyhydroxy ester, a heterocyclic polycarboxylic acid ester, a compound having at least one ether group and at least one ketone group, or a mixture of any two more thereof. In some embodiments, the at least one additional internal electron donor comprises an aryl diester, acylated catechol, carbonated catechol, or alkoxyalkyl ether. In some embodiments, the at least one additional internal electron donor comprises an aryl diester. The internal electron donor can comprise a phthalate compound or a substituted phenylene diester.

The selectivity control agent used in accordance with the present disclosure is an organosilicon compound. Examples of suitable organosilicon compounds include but are not limited to propyltriethoxysilane, diisobutyldimethoxysilane, n-propyltrimethoxysilane, or mixtures thereof. Use of the selectivity control agent is believed to facilitate production of very high melt flow rate polymers while also producing a polymer product with high bulk density, low fines, and good operability. In one aspect, an organosilicon compound can be used in conjunction with an activity limiting agent, such as pentyl valerate. In some embodiments, the selectively control agent includes propyltriethoxysilane, diisobutyldimethoxysilane, n-propyltrimethoxysilane, or mixtures thereof and is used in combination with an activity limiting agent. The selectivity control agent and the activity limiting agent can both be considered external electron donors, forming a mixed external electron donor. The molar ratio of activity limiting agent to selectivity control agent can be from about 40:60 to about 80:20, such as from about 50:50 to about 70:30. The mixed external electron donor may be used to control xylene soluble content, especially at higher hydrogen ratios in the reactor by adding greater amounts of the mixed external electron donor.

In one aspect, the process for producing the polymer can be carried out in a gas phase reactor. The catalyst used according to the process has been found to produce high melt flow rate polymers while still operating at a relatively low hydrogen partial pressure in comparison to past processes. For instance, in one aspect the hydrogen partial pressure within the reactor can be maintained below 60 psi, such as less than about 58 psi. Likewise, lowering the propylene partial pressure during the process can increase the melt flow rate of the polymer being produced.

The reactor temperature can also be controlled and manipulated in order to optimize production of the polymer. For example, in one aspect, the reactor temperature can be from about 68° C. to about 75° C. Alternatively, higher temperatures can be used. For instance, in an alternative embodiment, the reactor temperature can be greater than about 75° C., such as greater than about 80° C., such as greater than about 85° C., such as greater than about 90° C. and generally less than about 95° C. In some embodiments, the reactor temperature is between about 65° C. and about 95° C., including about 65° C., about 70° C., about 75° C., about 80° C., about 85° C., about 90° C., and about 95° C. The reactor temperature can be at about 72° C. or higher, such as at about 80° C. to about 90° C. Higher reactor temperatures can increase the hydrogen response and thus enable production of polymers having higher melt flow rates at lower hydrogen concentrations in comparison to operating the reactor at lower temperatures. Higher reactor temperatures can also reducing the weight average molecular weight and reducing the molecular weight distribution, which facilitate the fiber blowing process during the production of meltblown webs.

In one aspect, the hydrogen ratio to other components in the reactor may be relatively high. In some embodiments, H2/C3 molar ratio during polymerization is between about 0.1 and about 0.3, including about 0.1, about 0.2, and about 0.3. As described above, the xylene solubles is controlled by changing the amount of external electron donor present, which is the amount of both the selectivity control agent and activity limiting agent. For higher melt flows with low xylene solubles, more external electron donor may be fed to the reactor. In one aspect, the external electron donor mix can include a mixture of pentyl valerate and propyltriethoxysilane at a molar ratio of about 50:50 to about 70:30. Combining high hydrogen concentration in the presence of the external electron donors and using particular catalyst systems as described below have been found to produce the polymers with ultrahigh melt flow rates.

Through the process of the present disclosure, polypropylene polymers can be produced having a melt flow rate of generally greater than about 900 g/10 min. For instance, the melt flow rate of the polymer can be from about 900 g/10 min to about 9000 g/10 min, such as from about 900 g/10 min to about 7000 g/10 min, including all increments of 5 g/10 min therebetween. In certain aspects, the melt flow rate of the polypropylene polymer can be from about 1000 g/10 min to about 7000 g/10 min. In certain aspects, the melt flow rate of the polypropylene polymer can be greater than about 1000 g/10 min, such as greater than about 1200 g/10 min, such as greater than about 1400 g/10 min, such as greater than about 1800 g/10 min, such as greater than about 2200 g/10 min, and such as greater than about 4000 g/10 min. In certain aspects, the melt flow rate of the polypropylene polymer can be greater than about 1400 g/10 min, such as greater than about 1800 g/10 min, such as greater than about 2200 g/10 min. In some embodiments, the melt flow rate of the polypropylene polymer may be less than about 9000 g/10 min, such as less than about 7000 g/10 min, such as less than about 4000 g/10 min. In some embodiments, the melt flow rate of the polypropylene polymer is greater than about 1300 g/10 min, such as greater than about 1400 g/10 min, greater than about 1500 g/10 min, greater than about 1600 g/10 min, greater than about 1700 g/10 min, greater than about 1800 g/10 min, greater than about 1900 g/10 min, greater than about 2000 g/10 min, greater than about 2100 g/10 min, greater than about 2200 g/10 min, greater than about 2300 g/10 min, greater than about 2400 g/10 min, greater than about 2500 g/10 min, greater than about 2600 g/10 min, greater than about 2700 g/10 min, greater than about 2800 g/10 min, greater than about 2900 g/10 min, greater than about 3000 g/10 min, greater than about 3100 g/10 min, greater than about 3200 g/10 min, greater than about 3300 g/10 min, greater than about 3400 g/10 min, greater than about 3500 g/10 min, greater than about 3600 g/10 min, greater than about 3700 g/10 min, greater than about 3800 g/10 min, greater than about 3900 g/10 min, and greater than about 4000 g/10 min. In some embodiments, the melt flow rate of the polypropylene polymer is from about 1300 g/10 min to about 2200 g/10 min, including about 1300 g/10 min, about 1400 g/10 min, about 1500 g/10 min, about 1600 g/10 min, about 1700 g/10 min, about 1800 g/10 min, about 1900 g/10 min, about 2000 g/10 min, about 2100 g/10 min, about 2200 g/10 min, about 2300 g/10 min, about 2400 g/10 min, about 2500 g/10 min, about 2600 g/10 min, about 2700 g/10 min, about 2800 g/10 min, about 2900 g/10 min, about 3000 g/10 min, about 3100 g/10 min, about 3200 g/10 min, about 3300 g/10 min, about 3400 g/10 min, about 3500 g/10 min, about 3600 g/10 min, about 3700 g/10 min, about 3800 g/10 min, about 3900 g/10 min, and about 4000 g/10 min.

The polypropylene polymer can be a polypropylene homopolymer. Polypropylene copolymers may also be formed through the process including polypropylene random copolymers and polypropylene block copolymers. Comonomers can include ethylene or butylene.

By using a Ziegler-Natta catalyst system, the polypropylene polymer can be formed having a molecular weight distribution (M_{w}/Mₙ) of generally greater than about 4.5 or greater than about 6. In some embodiments, the polypropylene polymer has a molecular weight distribution of greater than about 4.5. In some embodiments, the polypropylene polymer has a molecular weight distribution of greater than about 6. In some embodiments, the polypropylene polymer has a molecular weight distribution of greater than about 7. In some embodiments, the polypropylene polymer has a molecular weight distribution of from about 6.0 to about 10.0, including about 6.0, about 6.5, about 7.0, about 7.5, about 8.0, about 8.5, about 9.0, about 9.5, and about 10.0. Maintaining the molecular weight distribution between about 6 and about 10 may provide various advantages when producing nonwoven webs. For example, maintaining the molecular weight distribution within the above range may produce webs that have dimensional stability and do not neck when produced and manipulated.

Polypropylene polymers made according to the present disclosure may having a M_{z+1}/M_{w} ratio of less than about 8, including less than about 7 and less than about 6. In some embodiments, the polypropylene polymer has an M_{z+1}/M_{w} ratio of less than about 7. In some embodiments, the polypropylene polymer has an M_{z+1}/M_{w} ratio of from about 6.0 to about 8.0, including about 6.0, about 7.0, and about 8.0.

Polypropylene polymers made according to the present disclosure generally have a controlled xylene soluble content. In some embodiments, the xylene soluble content is less than about 4.0% by weight. In some embodiments, the xylene soluble content is of from about 1.5% by weight to about 4% by weight, including about 1.5% by weight, about 2.0% by weight, about 2.5% by weight, about 3.0% by weight, about 3.5% by weight, and about 4.0% by weight. The xylene soluble content can be less than about 2% by weight. Lower xylene soluble content may offer processing advantages while higher amounts may produce nonwovens with a softer feel.

The polypropylene polymers described herein may have a melting temperature of greater than about 155° C., including greater than about 160° C., greater than about 165° C., greater than about 170° C., greater than about 175° C., and greater than about 180° C. In some embodiments, the polypropylene polymer exhibits a melting temperature of from about 155° C. to about 180° C., including about 155° C., about 160° C., about 165° C., about 170° C., about 175° C., and about 180° C. In some embodiments, the polypropylene polymer exhibits a melting temperature of from about 155° C. to about 165° C.

In some embodiments, the polypropylene polymer has a weight averaged molecular weight (Mw) less than about 80,000 g/mol, including less than about 75,000 g/mol, less than about 70,000 g/mol, less than about 65,000 g/mol, less than about 60,000 g/mol, less than about 55,000 g/mol, less than about 50,000 g/mol. In some embodiments, the polypropylene polymer has a weight averaged molecular weight of from about 55,000 g/mol to about 70,000 g/mol, including about 55,000 g/mol, about 60,000 g/mol, about 65,000 g/mol, and about 70,000 g/mol.

The polypropylene polymer of the present disclosure can have a number average molecular weight (Mn) of less than about 8,500 g/mol, including less than about 8,000 g/mol, less than about 7,700 g/mol, and less than about 7,000 g/mol. In some embodiments, the polypropylene polymer has a number averaged molecular weight of less than about 8,500 g/mol. In some embodiments, the polypropylene polymer has a number averaged molecular weight of from about 7,000 g/mol to about 8,000 g/mol, including about 7,000 g/mol, about 7,500 g/mol, and about 8,000 g/mol.

As described above, the polypropylene polymer is Ziegler-Natta catalyzed. As described herein, the Ziegler-Natta catalyst may comprise an internal electron donor, the internal electron donor including a substituted phenylene diester or a phthalate compound. The catalyst can include a solid catalyst component that can vary depending upon the particular application.

The solid catalyst component can include (i) magnesium, (ii) a transition metal compound of an element from Periodic Table groups IV to VIII, (iii) a halide, an oxyhalide, and/or an alkoxide of (i) and/or (ii), and (iv) combinations of (i), (ii), and (iii). Nonlimiting examples of suitable catalyst components include halides, oxyhalides, and alkoxides of magnesium, manganese, titanium, vanadium, chromium, molybdenum, zirconium, hafnium, and combinations thereof.

In one embodiment, the preparation of the catalyst component involves halogenation of mixed magnesium and titanium alkoxides.

In various embodiments, the catalyst component is a magnesium moiety compound (MagMo), a mixed magnesium titanium compound (MagTi), or a benzoate-containing magnesium chloride compound (BenMag). In one embodiment, the catalyst precursor is a magnesium moiety (“MagMo”) precursor. The MagMo precursor includes a magnesium moiety. Nonlimiting examples of suitable magnesium moieties include anhydrous magnesium chloride and/or its alcohol adduct, magnesium alkoxide or aryloxide, mixed magnesium alkoxy halide, and/or carboxylated magnesium dialkoxide or aryloxide. In one embodiment, the MagMo precursor is a magnesium di(C₁₋₄)alkoxide. In a further embodiment, the MagMo precursor is diethoxymagnesium.

In another embodiment, the catalyst component is a mixed magnesium/titanium compound (“MagTi”). The “MagTi precursor” has the formula Mg_{d}Ti(OR^{e})fX_{g} wherein R^{e} is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine, preferably chlorine; d is 0.5 to 56, or 2 to 4; f is 2 to 116 or 5 to 15; and g is 0.5 to 116, or 1 to 3. The precursors are prepared by controlled precipitation through removal of an alcohol from the reaction mixture used in their preparation. In an embodiment, a reaction medium comprises a mixture of an aromatic liquid, especially a chlorinated aromatic compound, most especially chlorobenzene, with an alkanol, especially ethanol. Suitable halogenating agents include titanium tetrabromide, titanium tetrachloride or titanium trichloride, especially titanium tetrachloride. Removal of the alkanol from the solution used in the halogenation, results in precipitation of the solid precursor, having especially desirable morphology and surface area. Moreover, the resulting precursors are particularly uniform in particle size.

In another embodiment, the catalyst precursor is a benzoate-containing magnesium chloride material (“BenMag”). As used herein, a “benzoate-containing magnesium chloride” (“BenMag”) can be a catalyst (i.e., a halogenated catalyst component) containing a benzoate internal electron donor. The BenMag material may also include a titanium moiety, such as a titanium halide. The benzoate internal donor is labile and can be replaced by other electron donors during catalyst and/or catalyst synthesis. Nonlimiting examples of suitable benzoate groups include ethyl benzoate, methyl benzoate, ethyl p-methoxybenzoate, methyl p-ethoxybenzoate, ethyl p-ethoxybenzoate, ethyl p-chlorobenzoate. In one embodiment, the benzoate group is ethyl benzoate. In an embodiment, the BenMag catalyst component may be a product of halogenation of any catalyst component (i.e., a MagMo precursor or a MagTi precursor) in the presence of a benzoate compound.

In another embodiment, the solid catalyst component can be formed from a magnesium moiety, a titanium moiety, an epoxy compound, an organosilicon compound, and an internal electron donor. In one embodiment, an organic phosphorus compound can also be incorporated into the solid catalyst component. For example, in one embodiment, a halide-containing magnesium compound can be dissolved in a mixture that includes an epoxy compound, an organic phosphorus compound, and a hydrocarbon solvent. The resulting solution can be treated with a titanium compound in the presence of an organosilicon compound and optionally with an internal electron donor to form a solid precipitate. The solid precipitate can then be treated with further amounts of a titanium compound. The titanium compound used to form the catalyst can have the following chemical formula:

Ti(OR)_{g}X_{4-g}

where each R is independently a C₁-C₄ alkyl; X is Br, Cl, or I; and g is 0, 1, 2, 3, or 4.

In some embodiments, the organosilicon is a monomeric or polymeric compound. The organosilicon compound may contain —Si—O—Si— groups inside of one molecule or between others. Other illustrative examples of an organosilicon compound include polydialkylsiloxane and/or tetraalkoxysilane. Such compounds may be used individually or as a combination thereof. The organosilicon compound may be used in combination with aluminum alkoxides and an internal electron donor.

The aluminum alkoxide referred to above may be of formula Al(OR′)₃ where each R′ is individually a hydrocarbon with up to 20 carbon atoms. This may include where each R′ is individually methyl, ethyl, n-propyl, iso-propyl, n-butyl, sec-butyl, tert-butyl, n-pentyl, iso-pentyl, neo-pentyl, etc.

Examples of the halide-containing magnesium compounds include magnesium chloride, magnesium bromide, magnesium iodide, and magnesium fluoride. In one embodiment, the halide-containing magnesium compound is magnesium chloride.

Illustrative of the epoxy compounds include, but are not limited to, glycidyl-containing compounds of the Formula:

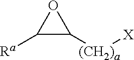

wherein “a” is from 1, 2, 3, 4, or 5, X is F, Cl, Br, I, or methyl, and R is H, alkyl, aryl, or cyclyl. In one embodiment, the alkylepoxide is epichlorohydrin. In some embodiments, the epoxy compound is a haloalkylepoxide or a nonhaloalkylepoxide.

According to some embodiments, the epoxy compound is selected from the group consisting of ethylene oxide; propylene oxide; 1,2-epoxybutane; 2,3-epoxybutane; 1,2-epoxyhexane; 1,2-epoxyoctane; 1,2-epoxydecane; 1,2-epoxydodecane; 1,2-epoxytetradecane; 1,2-epoxyhexadecane; 1,2-epoxyoctadecane; 7,8-epoxy-2-methyloctadecane; 2-vinyl oxirane; 2-methyl-2-vinyl oxirane; 1,2-epoxy-5-hexene; 1,2-epoxy-7-octene; 1-phenyl-2,3-epoxypropane; 1-(1-naphthyl)-2,3-epoxypropane; 1-cyclohexyl-3,4-epoxybutane; 1,3-butadiene dioxide; 1,2,7,8-diepoxyoctane; cyclopentene oxide; cyclooctene oxide; α-pinene oxide; 2,3-epoxynorbomane; limonene oxide; cyclodecane epoxide; 2,3,5,6-diepoxynorbomane; styrene oxide; 3-methylstyrene oxide; 1,2-epoxybutylbenzene; 1,2-epoxyoctylbenzene; stilbene oxide; 3-vinylstyrene oxide; 1-(1-methyl-1,2-epoxyethyl)-3-(1-methylvinyl benzene); 1,4-bis(1,2-epoxypropyl)benzene; 1,3-bis(1,2-epoxy-1-methylethyl)benzene; 1,4-bis(1,2-epoxy-1-methylethyl)benzene; epifluorohydrin; epichlorohydrin; epibromohydrin; hexafluoropropylene oxide; 1,2-epoxy-4-fluorobutane; 1-(2,3-epoxypropyl)-4-fluorobenzene; 1-(3,4-epoxybutyl)-2-fluorobenzene; 1-(2,3-epoxypropyl)-4-chlorobenzene; 1-(3,4-epoxybutyl)-3-chlorobenzene; 4-fluoro-1,2-cyclohexene oxide; 6-chloro-2,3-epoxybicyclo[2.2.1]heptane; 4-fluorostyrene oxide; 1-(1,2-epoxypropyl)-3-trifluorobenzene; 3-acetyl-1,2-epoxypropane; 4-benzoyl-1,2-epoxybutane; 4-(4-benzoyl)phenyl-1,2-epoxybutane; 4,4′-bis(3,4-epoxybutyl)benzophenone; 3,4-epoxy-1-cyclohexanone; 2,3-epoxy-5-oxobicyclo[2.2.1]heptane; 3-acetylstyrene oxide; 4-(1,2-epoxypropyl)benzophenone; glycidyl methyl ether; butyl glycidyl ether; 2-ethylhexyl glycidyl ether; allyl glycidyl ether; ethyl 3,4-epoxybutyl ether; glycidyl phenyl ether; glycidyl 4-tert-butylphenyl ether; glycidyl 4-chlorophenyl ether; glycidyl 4-methoxyphenyl ether; glycidyl 2-phenylphenyl ether; glycidyl 1-naphthyl ether; glycidyl 2-phenylphenyl ether; glycidyl 1-naphthyl ether; glycidyl 4-indolyl ether; glycidyl N-methyl-α-quinolon-4-yl ether; ethyleneglycol diglycidyl ether; 1,4-butanediol diglycidyl ether; 1,2-diglycidyloxybenzene; 2,2-bis(4-glycidyloxyphenyl)propane; tris(4-glycidyloxyphenyl)methane; poly(oxypropylene)triol triglycidyl ether; a glycidic ether of phenol novolac; 1,2-epoxy-4-methoxycyclohexane; 2,3-epoxy-5,6-dimethoxybicyclo[2.2.1]heptane; 4-methoxystyrene oxide; 1-(1,2-epoxybutyl)-2-phenoxybenzene; glycidyl formate; glycidyl acetate; 2,3-epoxybutyl acetate; glycidyl butyrate; glycidyl benzoate; diglycidyl terephthalate; poly(glycidyl acrylate); poly(glycidyl methacrylate); a copolymer of glycidyl acrylate with another monomer; a copolymer of glycidyl methacrylate with another monomer; 1,2-epoxy-4-methoxycarbonylcyclohexane; 2,3-epoxy-5-butoxycarbonylbicyclo[2.2.1]heptane; ethyl 4-(1,2-epoxyethyl)benzoate; methyl 3-(1,2-epoxybutyl)benzoate; methyl 3-(1,2-epoxybutyl)-5-pheylbenzoate; N,N-glycidyl-methylacetamide; N,N-ethylglycidylpropionamide; N,N-glycidylmethylbenzamide; N-(4,5-epoxypentyl)-N-methyl-benzamide; N,N-diglycylaniline; bis(4-diglycidylaminophenyl)methane; poly(N,N-glycidylmethylacrylamide); 1,2-epoxy-3-(diphenylcarbamoyl)cyclohexane; 2,3-epoxy-6-(dimethylcarbamoyl)bicycle[2.2.1]heptane; 2-(dimethylcarbamoyl)styrene oxide; 4-(1,2-epoxybutyl)-4′-(dimethylcarbamoyl)biphenyl; 4-cyano-1,2-epoxybutane; 1-(3-cyanophenyl)-2,3-epoxybutane; 2-cyanostyrene oxide; and 6-cyano-1-(1,2-epoxy-2-phenylethyl)naphthalene.

As an example of the organic phosphorus compound, phosphate acid esters such as trialkyl phosphate acid ester may be used. Such compounds may be represented by the formula:

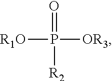

wherein R₁, R₂, and R₃ are each independently selected from the group consisting of methyl, ethyl, and linear or branched (C₃-C₁₀) alkyl groups. In one embodiment, the trialkyl phosphate acid ester is tributyl phosphate acid ester.

In still another embodiment, a substantially spherical MgCl₂-nEtOH adduct may be formed by a spray crystallization process. In the process, an MgCl₂-nROH melt, where n is 1-6, is sprayed inside a vessel while conducting inert gas at a temperature of 20-80° C. into the upper part of the vessel. The melt droplets are transferred to a crystallization area into which inert gas is introduced at a temperature of −50 to 20° C. crystallizing the melt droplets into nonagglomerated, solid particles of spherical shape. The spherical MgCl₂ particles are then classified into the desired size. Particles of undesired size can be recycled. In preferred embodiments for catalyst synthesis the spherical MgCl₂ precursor has an average particle size (Malvern d₅₀) of between about 15-150 microns, preferably between 20-100 microns, and most preferably between 35-85 microns.

The catalyst component may be converted to a solid catalyst by way of halogenation. Halogenation includes contacting the catalyst component with a halogenating agent in the presence of the internal electron donor. Halogenation converts the magnesium moiety present in the catalyst component into a magnesium halide support upon which the titanium moiety (such as a titanium halide) is deposited. Not wishing to be bound by any particular theory, it is believed that during halogenation the internal electron donor (1) regulates the position of titanium on the magnesium-based support, (2) facilitates conversion of the magnesium and titanium moieties into respective halides and (3) regulates the crystallite size of the magnesium halide support during conversion. Thus, provision of the internal electron donor yields a catalyst composition with enhanced stereoselectivity.

In an embodiment, the halogenating agent is a titanium halide having the formula Ti(OR^{e})_{f}Xₕ wherein R^{e} and X are defined as above, f is an integer from 0 to 3; h is an integer from 1 to 4; and f+h is 4. In an embodiment, the halogenating agent is TiCl₄. In a further embodiment, the halogenation is conducted in the presence of a chlorinated or a non-chlorinated aromatic liquid, such as dichlorobenzene, o-chlorotoluene, chlorobenzene, benzene, toluene, or xylene. In yet another embodiment, the halogenation is conducted by use of a mixture of halogenating agent and chlorinated aromatic liquid comprising from 40 to 60 volume percent halogenating agent, such as TiCl₄.

The reaction mixture can be heated during halogenation. The catalyst component and halogenating agent are contacted initially at a temperature of less than about 10° C., such as less than about 0° C., such as less than about −10° C., such as less than about −20° C., such as less than about −30° C. The initial temperature is generally greater than about −50° C., such as greater than about −40° C. The mixture is then heated at a rate of 0.1 to 10.0° C./minute, or at a rate of 1.0 to 5.0° C./minute. The internal electron donor may be added later, after an initial contact period between the halogenating agent and catalyst component. Temperatures for the halogenation are from 20° C. to 150° C. (or any value or subrange therebetween), or from 0° C. to 120° C. Halogenation may be continued in the substantial absence of the internal electron donor for a period from 5 to 60 minutes, or from 10 to 50 minutes.

The manner in which the catalyst component, the halogenating agent, and the internal electron donor are contacted may be varied. In an embodiment, the catalyst component is first contacted with a mixture containing the halogenating agent and a chlorinated aromatic compound. The resulting mixture is stirred and may be heated if desired. Next, the internal electron donor is added to the same reaction mixture without isolating or recovering of the precursor. The foregoing process may be conducted in a single reactor with addition of the various ingredients controlled by automated process controls.

In one embodiment, the catalyst component is contacted with the internal electron donor before reacting with the halogenating agent.

Contact times of the catalyst component with the internal electron donor are at least 10 minutes, or at least 15 minutes, or at least 20 minutes, or at least 1 hour at a temperature from at least −30° C., or at least −20° C., or at least 10° C. up to a temperature of 150° C., or up to 120° C., or up to 115° C., or up to 110° C.

In one embodiment, the catalyst component, the internal electron donor, and the halogenating agent are added simultaneously or substantially simultaneously.

The halogenation procedure may be repeated one, two, three, or more times as desired. In an embodiment, the resulting solid material is recovered from the reaction mixture and contacted one or more times in the absence (or in the presence) of the same (or different) internal electron donor components with a mixture of the halogenating agent in the chlorinated aromatic compound for at least about 10 minutes, or at least about 15 minutes, or at least about 20 minutes, and up to about 10 hours, or up to about 45 minutes, or up to about 30 minutes, at a temperature from at least about −20° C., or at least about 0° C., or at least about 10° C., to a temperature up to about 150° C., or up to about 120° C., or up to about 115° C.

After the foregoing halogenation procedure, the resulting solid catalyst composition is separated from the reaction medium employed in the final process, by filtering for example, to produce a moist filter cake. The moist filter cake may then be rinsed or washed with a liquid diluent to remove unreacted TiCl₄ and may be dried to remove residual liquid, if desired. Typically the resultant solid catalyst composition is washed one or more times with a “wash liquid,” which is a liquid hydrocarbon such as an aliphatic hydrocarbon such as isopentane, isooctane, isohexane, hexane, pentane, or octane. The solid catalyst composition then can be separated and dried or slurried in a hydrocarbon, especially a relatively heavy hydrocarbon such as mineral oil for further storage or use.

In one embodiment, the resulting solid catalyst composition has a titanium content of from about 1.0 percent by weight to about 6.0 percent by weight, based on the total solids weight, or from about 1.5 percent by weight to about 4.5 percent by weight, or from about 2.0 percent by weight to about 3.5 percent by weight. The weight ratio of titanium to magnesium in the solid catalyst composition is suitably between about 1:3 and about 1:160, or between about 1:4 and about 1:50, or between about 1:6 and 1:30. In an embodiment, the internal electron donor may be present in the catalyst composition in a molar ratio of internal electron donor to magnesium of from about 0.005:1 to about 1:1, or from about 0.01:1 to about 0.4:1. Weight percent is based on the total weight of the catalyst composition.

The catalyst composition may be further treated by one or more of the following procedures prior to or after isolation of the solid catalyst composition. The solid catalyst composition may be contacted (halogenated) with a further quantity of titanium halide compound, if desired; it may be exchanged under metathesis conditions with an acid chloride, such as phthaloyl dichloride or benzoyl chloride; and it may be rinsed or washed, heat treated; or aged. The foregoing additional procedures may be combined in any order or employed separately, or not at all.

As described above, the catalyst composition can include a combination of a magnesium moiety, a titanium moiety, and the internal electron donor. The catalyst composition is produced by way of the foregoing halogenation procedure which converts the catalyst component and the internal electron donor into the combination of the magnesium and titanium moieties, into which the internal electron donor is incorporated. The catalyst component from which the catalyst composition is formed can be any of the above described catalyst precursors, including the magnesium moiety precursor, the mixed magnesium/titanium precursor, the benzoate-containing magnesium chloride precursor, the magnesium, titanium, epoxy, and phosphorus precursor, or the spherical precursor.

Various different types of internal electron donors may be incorporated into the solid catalyst component. In one embodiment, the internal electron donor is an aryl diester, such as a phenylene-substituted diester. In one embodiment, the internal electron donor may have the following chemical structure:

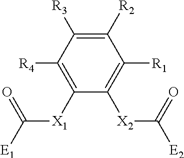

wherein R₁ R₂, R₃ and R₄ are each a hydrocarbyl group having from 1 to 20 carbon atoms, the hydrocarbyl group having a branched or linear structure or comprising a cycloalkyl group having from 7 to 15 carbon atoms, and where E₁ and E₂ are the same or different and selected from the group consisting of an alkyl having 1 to 20 carbon atoms, a substituted alkyl having 1 to 20 carbon atoms, an aryl having 1 to 20 carbon atoms, a substituted aryl having 1 to 20 carbon atoms, or an inert functional group having 1 to 20 carbon atoms and optionally containing heteroatoms, and wherein X₁ and X₂ are each O, S, an alkyl group, or NR₅ and wherein R₅ is a hydrocarbyl group having 1 to 20 carbon atoms or is hydrogen.

As used herein, the term “hydrocarbyl” and “hydrocarbon” refer to substituents containing only hydrogen and carbon atoms, including branched or unbranched, saturated or unsaturated, cyclic, polycyclic, fused, or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, Br, I), N, O, P, B, S, and Si. A substituted hydrocarbyl group also includes a halohydrocarbyl group and a silicon-containing hydrocarbyl group. As used herein, the term “halohydrocarbyl” group refers to a hydrocarbyl group that is substituted with one or more halogen atoms. As used herein, the term “silicon-containing hydrocarbyl group” is a hydrocarbyl group that is substituted with one or more silicon atoms. The silicon atom(s) may or may not be in the carbon chain.

In one aspect, the substituted phenylene diester has the following structure (I):

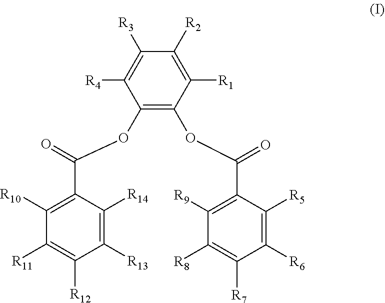

In an embodiment, structure (I) includes R₁ and R₃ that is an isopropyl group. Each of R₂, R₄, and R₅-R₁₄ is hydrogen.

In an embodiment, structure (I) includes each of R₁, R₅, and R₁₀ as a methyl group and R₃ is a t-butyl group Each of R₂, R₄, R₆-R₉, and R₁₁-R₁₄ is hydrogen.

In an embodiment, structure (I) includes each of R₁, R₇, and R₁₂ as a methyl group and R₃ is a t-butyl group. Each of R₂, R₄, R₅, R₆, R₈, R₉, R₁₀, R₁₁, R₁₃, and R₁₄ is hydrogen.

In an embodiment, structure (I) includes R₁ as a methyl group and R₃ is a t-butyl group. Each of R₇ and R₁₂ is an ethyl group. Each of R₂, R₄, R₅, R₆, R₈, R₉, R₁₀, R₁₁, R₁₃, and R₁₄ is hydrogen.

In an embodiment, structure (I) includes each of R₁, R₅, R₇, R₉, R₁₀, R₁₂, and R₁₄ as a methyl group and R₃ is a t-butyl group. Each of R₂, R₄, R₆, R₈, R₁₁, and R₁₃ is hydrogen.

In an embodiment, structure (I) includes R₁ as a methyl group and R₃ is a t-butyl group. Each of R₅, R₇, R₉, R₁₀, R₁₂, and R₁₄ is an i-propyl group. Each of R₂, R₄, R₆, R₈, R₁₁, and R₁₃ is hydrogen.

In an embodiment, the substituted phenylene aromatic diester has a structure selected from the group consisting of structures (II)-(V), including alternatives for each of R₁ to R₁₄, that are described in detail in U.S. Pat. No. 8,536,372, which is incorporated herein by reference.

In an embodiment, structure (1) includes R₁ that is a methyl group and R₃ is a t-butyl group. Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group Each of R₇ and R₁₂ is a fluorine atom Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a chlorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a bromine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group Each of R₇ and R₁₂ is an iodine atom Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₆, R₇, R₁₁, and R₁₂ is a chlorine atom. Each of R₂, R₄, R₅, R₈, R₉, R₁₀, R₁₃, and R₁₄ is hydrogen.

In an embodiment, structure (I) includes R₁ that is a methyl group and R₃ is a t-butyl group. Each of R₆, R₈, R₁₁, and R₁₃ is a chlorine atom. Each of R₂, R₄, R₅, R₇, R₉, R₁₀, R₁₂, and R₁₄ is hydrogen.

In an embodiment, structure (I) includes R₁ that is a methyl group and R₃ is a t-butyl group Each of R₂, R₄, and R₅-R₁₄ is a fluorine atom.

In an embodiment, structure (I) includes R₁ that is a methyl group and R₃ is a t-butyl group Each of R₇ and R₁₂ is a trifluoromethyl group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is an ethoxycarbonyl group. Each of R₂, R₄, R₅, R₆, R₈, R₉, R₁₀, R₁₁, R₁₃, and R₁₄ is hydrogen.

In an embodiment, R₁ is methyl group and R₃ is a t-butyl group Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group Each of R₇ and R₁₂ is a diethylamino group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a 2,4,4-trimethylpentan-2-yl group. Each of R₂, R₄, and R₅-R₁₄ is hydrogen.

In an embodiment, structure (I) includes R₁ and R₃, each of which is a sec-butyl group Each of R₂, R₄, and R₅-R₁₄ is hydrogen.

In an embodiment, structure (1) includes R₁ and R₄ that are each a methyl group. Each of R₂, R₃, R₅-R₉, and R₁₀-R₁₄ is hydrogen.

In an embodiment, structure (1) includes R₁ that is a methyl group. R₄ is an i-propyl group. Each of R₂, R₃, R₅-R₉, and R₁₀-R₁₄ is hydrogen.

In an embodiment, structure (I) includes R₁, R₃, and R₄, each of which is an i-propyl group. Each of R₂, R₅-R₉, and R₁₀-R₁₄ is hydrogen.

In another aspect, the internal electron donor can be a phthalate compound. For example, the phthalate compound can be dimethyl phthalate, diethyl phthalate, dipropyl phthalate, diisopropyl phthalate, dibutyl phthalate, diisobutyl phthalate, diamyl phthalate, diisoamyl phthalate, methylbutyl phthalate, ethylbutyl phthalate, or ethylpropyl phthalate.

In addition to the solid catalyst component as described above, the catalyst system of the present disclosure can also include a cocatalyst. The cocatalyst may include hydrides, alkyls, or aryls of aluminum, lithium, zinc, tin, cadmium, beryllium, magnesium, and combinations thereof. In an embodiment, the cocatalyst is a hydrocarbyl aluminum cocatalyst represented by the formula R₃Al wherein each R is an alkyl, cycloalkyl, aryl, or hydride radical; at least one R is a hydrocarbyl radical; two or three R radicals can be joined in a cyclic radical forming a heterocyclic structure; each R can be the same or different; and each R, which is a hydrocarbyl radical, has 1 to 20 carbon atoms, and preferably 1 to 10 carbon atoms. In a further embodiment, each alkyl radical can be straight or branched chain and such hydrocarbyl radical can be a mixed radical, i.e., the radical can contain alkyl, aryl, and/or cycloalkyl groups. Nonlimiting examples of suitable radicals are: methyl, ethyl, n-propyl, isopropyl, n-butyl, isobutyl, tert-butyl, n-pentyl, neopentyl, n-hexyl, 2-methylpentyl, n-heptyl, n-octyl, isooctyl, 2-ethylhexyl, 5,5-dimethylhexyl, n-nonyl, n-decyl, isodecyl, n-undecyl, n-dodecyl.

Nonlimiting examples of suitable hydrocarbyl aluminum compounds are as follows: triisobutylaluminum, tri-n-hexylaluminum, diisobutylaluminum hydride, di-n-hexylaluminum hydride, isobutylaluminum dihydride, n-hexylaluminum dihydride, diisobutylhexylaluminum, isobutyldihexylaluminum, trimethylaluminum, triethylaluminum, tri-n-propylaluminum, triisopropylaluminum, tri-n-butylaluminum, tri-n-octylaluminum, tri-n-decylaluminum, tri-n-dodecylaluminum. In an embodiment, the cocatalyst is selected from triethylaluminum, triisobutylaluminum, tri-n-hexylaluminum, diisobutylaluminum hydride, and di-n-hexylaluminum hydride.

In an embodiment, the cocatalyst is triethylaluminum. The molar ratio of aluminum to titanium is from about 5:1 to about 500:1, or from about 10:1 to about 200:1, or from about 15:1 to about 150:1, or from about 20:1 to about 100:1. In another embodiment, the molar ratio of aluminum to titanium is about 45:1.

Suitable catalyst compositions can include the solid catalyst component, a co-catalyst, and an external electron donor that can be a mixed external electron donor (M-EED) of two or more different components. Suitable external electron donors or “external donor” include one or more activity limiting agents (ALA) and/or one or more selectivity control agents (SCA). As used herein, an “external donor” is a component or a composition comprising a mixture of components added independent of procatalyst formation that modifies the catalyst performance. As used herein, an “activity limiting agent” is a composition that decreases catalyst activity as the polymerization temperature in the presence of the catalyst rises above a threshold temperature (e.g., temperature greater than about 95° C.). A “selectivity control agent” is a composition that improves polymer tacticity, wherein improved tacticity is generally understood to mean increased tacticity or reduced xylene solubles or both. It should be understood that the above definitions are not mutually exclusive and that a single compound may be classified, for example, as both an activity limiting agent and a selectivity control agent.

A selectivity control agent in accordance with the present disclosure is generally an organosilicon compound. For example, in one aspect, the selectively control agent can be an alkoxysilane.

In one embodiment, the alkoxysilane can have the following general formula: SiRₘ(OR′)₄₋ₘ (I) where R independently each occurrence is hydrogen or a hydrocarbyl or an amino group optionally substituted with one or more substituents containing one or more Group 14, 15, 16, or 17 heteroatoms, said R containing up to 20 atoms not counting hydrogen and halogen; R′ is a C₁₋₄ alkyl group; and m is 0, 1, 2 or 3. In an embodiment, R is C₆₋₁₂ aryl, alkyl or aralkyl, C₃₋₁₂ cycloalkyl, C₃₋₁₂ branched alkyl, or C₃₋₁₂ cyclic or acyclic amino group, R′ is C₁₋₄ alkyl, and m is 1 or 2. In one embodiment, for instance, the second selectivity control agent may comprise n-propyltriethoxysilane. Other selectively control agents that can be used include propyltriethoxysilane or diisobutyldimethoxysilane. In some embodiments, the selectively control agent comprises propyltriethoxysilane, diisobutyldimethoxysilane, n-propyltrimethoxysilane, or mixtures thereof and may be used in combination with an activity limiting agent as described below.

In one embodiment, the catalyst system may include an activity limiting agent (ALA). An ALA inhibits or otherwise prevents polymerization reactor upset and ensures continuity of the polymerization process. Typically, the activity of Ziegler-Natta catalysts increases as the reactor temperature rises. Ziegler-Natta catalysts also typically maintain high activity near the melting point temperature of the polymer produced. The heat generated by the exothermic polymerization reaction may cause polymer particles to form agglomerates and may ultimately lead to disruption of continuity for the polymer production process. The ALA reduces catalyst activity at elevated temperature, thereby preventing reactor upset, reducing (or preventing) particle agglomeration, and ensuring continuity of the polymerization process.

The activity limiting agent may be a carboxylic acid ester. The aliphatic carboxylic acid ester may be a C₄-C₃₀ aliphatic acid ester, may be a mono- or a poly- (two or more) ester, may be straight chain or branched, may be saturated or unsaturated, and any combination thereof. The C₄-C₃₀ aliphatic acid ester may also be substituted with one or more Group 14, 15, or 16 heteroatom containing substituents. Nonlimiting examples of suitable C_{4-C30} aliphatic acid esters include C₁₋₂₀ alkyl esters of aliphatic C₄₋₃₀ monocarboxylic acids, C₁₋₂₀ alkyl esters of aliphatic C₈₋₂₀ monocarboxylic acids, C₁₋₄ allyl mono- and diesters of aliphatic C₄₋₂₀ monocarboxylic acids and dicarboxylic acids, C₁₋₄ alkyl esters of aliphatic C₈₋₂₀ monocarboxylic acids and dicarboxylic acids, and C₄₋₂₀ mono- or polycarboxylate derivatives of C₂₋₁₀₀ (poly)glycols or C₂₋₁₀₀ (poly)glycol ethers. In a further embodiment, the C₄-C₃₀ aliphatic acid ester may be a laurate, a myristate, a palmitate, a stearate, an oleates, a sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-oleates, glyceryl tri(acetate), glyceryl tri-ester of C₂₋₄₀ aliphatic carboxylic acids, and mixtures thereof. In a further embodiment, the C₄-C₃₀ aliphatic ester is isopropyl myristate, di-n-butyl sebacate, and/or pentyl valerate. In a further embodiment, the C₄-C₃₀ aliphatic ester is isopropyl myristate and/or pentyl valerate.

In one embodiment, the selectivity control agent and/or activity limiting agent can be added into the reactor separately. In another embodiment, the selectivity control agent and the activity limiting agent can be mixed together in advance and then added into the reactor as a mixture. In addition, the selectivity control agent and/or activity limiting agent can be added into the reactor in different ways. For example, in one embodiment, the selectivity control agent and/or the activity limiting agent can be added directly into the reactor, such as into a fluidized bed reactor. Alternatively, the selectivity control agent and/or activity limiting agent can be added indirectly to the reactor volume by being fed through, for instance, a cycle loop. The selectivity control agent and/or activity limiting agent can combine with the catalyst particles within the cycle loop prior to being fed into the reactor.

The catalyst system of the present disclosure as described above can be used for producing olefin-based polymers. The process includes contacting an olefin with the catalyst system under polymerization conditions.

One or more olefin monomers can be introduced into a polymerization reactor to react with the catalyst system and to form a polymer, such as a fluidized bed of polymer particles. The olefin monomer for instance, can be propylene. Any suitable reactor may be used including a fluidized bed reactor, a stirred gas reactor, moving packed bed reactor, a multizone reactor, a bulk phase reactor, a slurry reactor or combinations thereof. Suitable commercial reactors include the UNIPOL reactor, the SPHERIPOL, the SPHERIZONE reactor and the like.

As used herein, “polymerization conditions” are temperature and pressure parameters within a polymerization reactor suitable for promoting polymerization between the catalyst composition and an olefin to form the desired polymer. The polymerization process may be a gas phase, a slurry, or a bulk polymerization process, operating in one, or more than one reactor.

In one embodiment, polymerization occurs by way of gas phase polymerization. As used herein, “gas phase polymerization” is the passage of an ascending fluidizing medium, the fluidizing medium containing one or more monomers, in the presence of a catalyst through a fluidized bed of polymer particles maintained in a fluidized state by the fluidizing medium. “Fluidization,” “fluidized,” or “fluidizing” is a gas-solid contacting process in which a bed of finely divided polymer particles is lifted and agitated by a rising stream of gas. Fluidization occurs in a bed of particulates when an upward flow of fluid through the interstices of the bed of particles attains a pressure differential and frictional resistance increment exceeding particulate weight. Thus, a “fluidized bed” is a plurality of polymer particles suspended in a fluidized state by a stream of a fluidizing medium. A “fluidizing medium” is one or more olefin gases, optionally a carrier gas (such as H₂ or N₂) and optionally a liquid (such as a hydrocarbon) which ascends through the gas-phase reactor.

A typical gas-phase polymerization reactor (or gas phase reactor) includes a vessel (i.e., the reactor), the fluidized bed, a distribution plate, inlet and outlet piping, a compressor, a cycle gas cooler or heat exchanger, and a product discharge system. The vessel includes a reaction zone and a velocity reduction zone, each of which is located above the distribution plate. The bed is located in the reaction zone. In an embodiment, the fluidizing medium includes propylene gas and at least one other gas such as an olefin and/or a carrier gas such as hydrogen or nitrogen.

In one embodiment, the contacting occurs by way of feeding the catalyst composition into a polymerization reactor and introducing the olefin into the polymerization reactor. In an embodiment, the cocatalyst can be mixed with the catalyst composition (pre-mix) prior to the introduction of the catalyst composition into the polymerization reactor. In another embodiment, the cocatalyst is added to the polymerization reactor independently of the catalyst composition. The independent introduction of the cocatalyst into the polymerization reactor can occur simultaneously, or substantially simultaneously, with the catalyst composition feed. In some embodiments, a cocatalyst and the external electron donor are fed to the polymerization reactor at a molar ratio of about 1.5 to about 15, including about 1.5, about 2.0, about 2.5, about 3.0, about 3.5, about 4.0, about 4.5, about 5.0, about 5.5, about 6.0, about 6.5, about 7.0, about 7.5, about 8.0, about 8.5, about 9.0, about 9.5, about 10, about 10.5, about 11, about 11.5, about 12, about 12.5, and about 13.

In one embodiment, the polymerization process may include a pre-activation step. Pre-activation includes contacting the catalyst composition with the co-catalyst and the selectivity control agent and/or the activity limiting agent. The resulting preactivated catalyst stream is subsequently introduced into the polymerization reaction zone and contacted with the olefin monomer to be polymerized. Optionally, additional quantities of the selectivity control agent and/or the activity limiting agent may be added.

The process can include mixing the selectivity control agent (and optionally the activity limiting agent) with the catalyst composition. The selectivity control agent can be complexed with the cocatalyst and mixed with the catalyst composition (pre-mix) prior to contact between the catalyst composition and the olefin. In another embodiment, the selectivity control agent and/or the activity limiting agent can be added independently to the polymerization reactor. In one embodiment, the selectivity control agent and/or the activity limiting agent can be fed to the reactor through a cycle loop.

The above process can be used to produce polypropylene polymers having very high melt flow rates. In addition, polymers can be produced having a relatively low amount of fines and having a relatively high bulk density. Polymers made according to the present disclosure, however, can contain fines in an amount less than about 8% by weight, such as less than about 7% by weight, such as less than about 6% by weight. The bulk density, for instance, can be greater than about 0.30 g/cc, such as greater than about 0.4 g/cc, such as greater than about 0.42 g/cc, such as greater than about 0.45 g/cc. The bulk density is generally less than about 0.6 g/cc, such as less than about 0.5 g/cc, such as less than about 0.4 g/cc.

Polypropylene polymers made according to the present disclosure can then be incorporated into various polymer compositions for producing molded articles. The polymer composition can contain the high melt flow rate polypropylene polymer in an amount generally greater than about 70% by weight, such as in an amount greater than about 80% by weight, such as in an amount greater than about 90% by weight, such as in an amount greater than about 95% by weight. The polymer composition can contain various different additives and ingredients. For instance, the polymer composition can contain one or more antioxidants. For example, in one aspect, the polymer composition can contain a sterically hindered phenolic antioxidant and/or a phosphite antioxidant. The polymer composition can also contain an acid scavenger, such as calcium stearate. In addition, the polymer composition can contain a coloring agent, a UV stabilizer, and the like. Each of the above additives can be present in the polymer composition generally in an amount from about 0.015 to about 2% by weight.

Alternatively, the high melt flow rate polypropylene polymer can be used as a processing aid. A processing aid can be a flow agent for improving the melt flow properties of other polymers, a lubricant, a mold release agent, a wax or the like. In some embodiments, the high melt flow rate polypropylene polymer includes a wax, a lubricant, a mold release agent, or a flow aid. In this embodiment, the high melt flow rate polypropylene polymer of the present disclosure can be present in a polymer composition in an amount of from about 2% by weight to about 50% by weight, including all increments of 1% therebetween. For example, the high melt flow rate polypropylene polymer can be present in a polymer composition in an amount less than about 50% by weight, such as less than 40% by weight, such as less than about 30% by weight, such as less than about 25% by weight, such as less than about 20% by weight, such as less than about 10% by weight, and generally greater than about 5% by weight. In some embodiments, the polypropylene polymer includes a processing aid combined with at least one other polymer exhibiting a lower melt flow rate, the polypropylene polymer being contained in the composition in an amount less than about 50% by weight. Polymers that can be combined with the high melt flow rate polypropylene polymer include other lower melt flow rate polypropylene polymers, polyethylene polymers, polyester polymers, and the like.

Polyolefin polymers, such as polypropylene polymers, with a very high melt flow rate are well suited for use in various different applications in order to produce various different articles and products. In some embodiments, the polyolefin polymers, such as polypropylene polymers, do not include any peroxides. High melt flow rate polymers generally have excellent flow properties that make the polymers easy to process, even in extruding or molding processes with very small dimensions. High melt flow rate polyolefin polymers, for instance, are well suited for forming small fibers and thin films. The polymer produced from the process is capable of producing fibers at ultra-low deniers and/or at higher processing speeds. For example, polyolefin polymers made according to the present disclosure are particularly well suited to forming meltblown fibers and meltblown nonwoven webs. Such fibers can be continuous or discontinuous and can have fiber diameters of less than about 5 microns, such as less than about 3 microns, such as less than about 2 microns, such as less than about 1 micron, and such as less than about 0.5 microns. Nonwoven webs made from the polymer are dimensionally stable and do not exhibit necking during production and handling. Meltblown nonwoven webs made from the fibers have excellent filtration properties making them well suited for use as a barrier layer. For example, meltblown webs made according to the present disclosure can make an excellent barrier to fluids, airborne contaminants, and microorganisms, such as viruses. Consequently, meltblown webs made according to the present disclosure are particularly well suited for incorporation into protective garments and apparel.

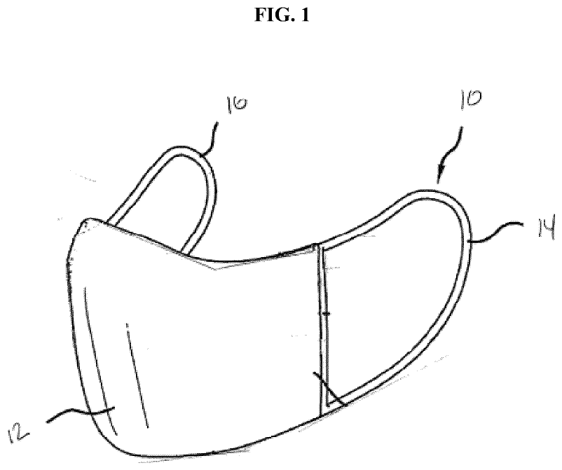

For instance, referring to FIG. 1, one embodiment of a face mask 10 that can be made using a meltblown web of the present disclosure is illustrated. The face mask 10 includes a body portion 12 attached to straps 14 and 16. Strap 14 and 16 are designed to extend around the ears of a user for maintaining the body portion 12 over the nose and mouth of the wearer. The body portion 12 can be made from the meltblown web of the present disclosure. For instance, the body portion 12 can be made from a single layer of meltblown material. Alternatively, the meltblown web of the present disclosure can be one of several layers used to form the body portion 12. For example, in one aspect, the body portion 12 can include the meltblown layer of the present disclosure positioned between two outer layers.

The polyolefin polymers, such as polypropylene polymers, with a very high melt flow rate as described herein are well suited for use in meltblown nonwoven applications. Provided in one aspect is a meltblown web comprised of nonwoven, meltblown fibers, the meltblown fibers being made from any one of the polymer compositions described herein.

Provided in one aspect is a meltblown fiber made from any one of the polymer compositions described herein, the meltblown fiber having a diameter of less than about 5 microns, including less than about 4.5 microns, less than about 4.0 microns, less than about 3.5 microns, less than about 3.0 microns, less than about 2.5 microns, less than about 2.0 microns. In some embodiments, the meltblown fiber has a diameter of less than about 3 microns. In some embodiments, the meltblown fiber has a diameter of about 5 microns, about 4.5 microns, about 4.0 microns, about 3.5 microns, about 3.0 microns, about 2.5 microns, about 2.0 microns or about 1.5 microns. In some embodiments, the meltblown fiber has a diameter of from about 1.5 to about 3.0 microns. The meltblown fiber size and its distribution may be determined by the resin MFR and/or the M_{z+1}/M_{w} ratio (high MW polymer chains).

Provided in one aspect is a nonwoven web including a multi-layer structure including: one or more meltblown layers including any one of the meltblown fibers described herein.

In some embodiments, the nonwoven web includes one meltblown layer. In some embodiments, the nonwoven web includes two or more meltblown layers. In some embodiments, the two or more meltblown layers include the same meltblown layers. In some embodiments, the two or more meltblown layers include the different meltblown layers.

In some embodiments, the nonwoven web further includes two or more spunbound layers including a spunbound fiber. In some embodiments, spunbound fiber is prepared from a polymer composition including a polypropylene polymer having one or more of the following characteristics: exhibiting a melt flow rate of from about 20 g/10 min to about 70 g/10 min; having a molecular weight distribution (M_{w}/Mₙ) of less than about 4; and having a xylene soluble content of from about 1.5% by weight to about 4% by weight.

In some embodiments, the polypropylene polymer has a M_{w}/Mₙ of from about 3.0 to about 4.0, including about 3.0, about 3.5 and about 4.0. In some embodiments, the polypropylene polymer has a weight averaged molecular weight of less than about 300,000 g/mol, including less than about 250,000, less than about 200,000, and less than about 150,000. In some embodiments, the polypropylene polymer has a weight averaged molecular weight of from about 150,000 to about 250,000, including about 150,000, about 200,000, and about 250,000. In some embodiments, the polypropylene polymer has a number averaged molecular weight of less than about 60,000 g/mol, including less than about 55,000 g/mol, less than about 50,0000 g/mol, less than about 45,000 g/mol, and less than about 40,000 g/mol. In some embodiments, the polypropylene polymer has a number averaged molecular weight of from about 40,000 to about 55,000 g/mol, including about 40,000 g/mol, about 45,000 g/mol, about 50,000 g/mol, and about 55,000 g/mol. In some embodiments, the polypropylene polymer exhibiting a melting temperature greater than 155° C.

In some embodiments, the nonwoven web comprises two or more spunblown layers. In some embodiments, the two or more spunblown layers comprise the same spunblown layers. In some embodiments, the two or more spunblown layers comprise the different spunblown layers.

In some embodiments, the nonwoven web has a multilayer structure comprising a first spunbound layer, a meltblown layer, and a second spunbound layer. In some embodiments, the first spunbound layer and the second spunbound layer are the same. In some embodiments, the first spunbound layer and the second spunbound layer are different.

In some embodiments, the nonwoven web has an air permeability of less than about 100 l/m²/sec, including less than about 95 l/m²/sec, less than about 90 l/m²/sec, less than about 85 l/m²/sec, less than about 80 l/m²/sec, less than about 75 l/m²/sec, less than about 70 l/m²/sec, less than about 65 l/m²/sec, less than about 60 l/m²/sec, less than about 65 l/m²/sec, less than about 50 l/m²/sec, less than about 55 l/m²/sec, and less than about 50 l/m²/sec. In some embodiments, the nonwoven web has an air permeability of from about 40 to about 80 l/m²/sec, including about 40 l/m²/sec, about 45 l/m²/sec, about 50 l/m²/sec, about 55 l/m²/sec, about 60 l/m²/sec, about 65 l/m²/sec, about 70 l/m²/sec, about 75 l/m²/sec, and 80 l/m²/sec. The air permeability may be determined by the meltblown fiber size (average fiber diameter) and/or the meltblown fiber size distribution (fiber size standard deviation).

In some embodiments, the nonwoven web has a machine direction (MD) tensile strength from about 2500 g/inch to about 3500 g/inch, including about 2500 g/inch, about 3000 g/inch, and about 3500 g/inch.

Provided in another aspect is a process for producing any one of the nonwoven webs disclosed herein including: contacting one or more meltblown layers with two or more spunbound layers at a bonding temperature of from about 130° C. to about 140° C.

The bonding temperature may be about 130° C., about 135° C., or about 140° C. In some embodiments, the bonding temperature is about 135° C.

The present invention, thus generally described, will be understood more readily by reference to the following examples, which are provided by way of illustration and are not intended to be limiting of the present invention.

### EXAMPLES

Example 1. Various different high melt flow rate polypropylene homopolymers were made in accordance with the present disclosure using two different catalysts, Catalyst A and Catalyst B. The preparation of these polypropylene are also described in PCT Application No. PCT/US2021/049547 filed on Sep. 9, 2021, which is incorporated by reference for the disclosure of such polymers. Sample Numbers 13 through 18 below were produced using Catalyst B, which is LYNX 1010 catalyst commercially available from the W.R. Grace and Company. The LYNX 1010 catalyst includes a solid catalyst component containing a magnesium moiety, a titanium moiety, an epoxy compound, and an organosilicon compound. The LYNX 1010 catalyst includes a phthalate compound as an internal electron donor.

Sample Numbers 1 through 12 and 19 through 21 below were produced using Catalyst A, a similar solid catalyst component but using a non-phthalate substituted phenylene diester internal electron donor.

Both catalyst systems were used in conjunction with a selectively control agent. The selectivity control agent used was propyltriethoxylsilane. The selectivity control agent was used with pentyl valerate as the activity limiting agent. The molar ratio of selectivity control agent to activity limiting agent was 40:60.

The reactor conducted polymerization in a gas-phase fluidized bed with a compressor and cooler connected to a cycle gas line.

Polypropylene resin powder was produced in the fluidized bed reactor using the above catalysts in combination with triethylaluminum (TEAl) as a cocatalyst.

The fluidized bed reactor was operated under the following conditions:
Reactor Temperature: 72° C. for Examples 1 through 17 or 80° C. for Example 18
Bed weight: 68 to 72 lbs
Superficial gas velocity: 1.0 to 1.6 ft/sec

All of the polymers were produced at hydrogen to monomer ratios of from about 0.11 to about 0.23. All of the polymers produced had a xylene soluble content of from 1.5% to 6% by weight and a molecular weight distribution of greater than 2.5. Catalyst productivity was in the range from 10 to 40 ton/kg of catalyst and averaged around 20 ton/kg. The ultra-high melt flow rate polymers were produced without having to use a peroxide. The polymer particle sizes were determined using the GRADEX sieve test.

The following samples were produced and the following results were obtained:

TABLE 3

| | | TEAl/ | | Xylene | | | | | | |
|---|---|---|---|---|---|---|---|---|---|---|
| | H2/C3 | External | Melt | Solubles - | Catalyst | | | | | |
| Sample | Molar | Donor Molar | Flow Rate | Wet Method | Productivity | Mw | Mn | | Mz | Mz + 1 |
| No. | Ratio | Feed Ratio | (g/10 min) | (wt %) | (kg/kg) | (g/mol) | (g/mol) | Mw/Mn | (g/mol) | (g/mol) |
| 1 | 0.1640 | 9.25 | 3477 | 5.43 | 39,919 | | | | | |
| 2 | 0.1127 | 3.95 | 919 | 2.85 | 33,000 | 75,200 | 8,500 | 8.9 | 323,900 | 977,700 |
| 3 | 0.1162 | 3.10 | 1590 | 2.48 | 32,566 | 72,700 | 8,000 | 9.1 | 337,300 | 1,040,200 |
| 4 | 0.1165 | 3.21 | 1532 | 3.45 | 38,077 | 75,000 | 8,200 | 9.2 | 343,700 | 1,036,300 |
| 5 | 0.1158 | 2.45 | 1411 | 1.64 | 25,000 | 75,000 | 8,200 | 9.2 | 334,800 | 977,200 |
| 6 | 0.1360 | 2.54 | 1938 | 2.50 | 22,098 | 70,100 | 7,500 | 9.4 | 344,000 | 1,078,300 |
| 7 | 0.1679 | 1.97 | 2461 | 1.92 | 16,071 | | | | | |
| 8 | 0.1679 | 2.05 | 2560 | 2.45 | 16,723 | | | | | |
| 9 | 0.1680 | 1.95 | 2782 | 2.43 | 15,184 | | | | | |
| 10 | 0.1673 | 1.95 | 2613 | 2.43 | 15,184 | 64,800 | 6,700 | 9.7 | 343,000 | 1,115,600 |
| 11 | 0.1679 | 2.02 | 2307 | 2.55 | 17,553 | | | | | |
| 12 | 0.1772 | 2.02 | 2511 | 1.92 | 11,149 | | | | | |
| 13 | 0.1616 | 4.02 | 1008 | 2.52 | 12,402 | 72,600 | 7,900 | 9.2 | 288,200 | 857,500 |
| 14 | 0.2196 | 4.95 | 1514 | 2.50 | 12,402 | 69,700 | 7,800 | 9 | 251,600 | 722,500 |
| 15 | 0.1700 | 6.08 | 1108 | 3.12 | 25,301 | | | | | |
| 16 | 0.1703 | 6.23 | 1509 | 5.42 | 23,333 | 91,900 | 7,600 | 12 | 570,700 | 1,639,800 |
| 17 | 0.1733 | 4.04 | 1204 | 3.78 | 24,138 | | | | | |
| 18 | 0.2049 | 5.16 | 2066 | 2.52 | 14,858 | 61,800 | 7,800 | 7.9 | 206,200 | 625,200 |

TABLE 4

| | | | | | | | | | | Settled | Average |
|---|---|---|---|---|---|---|---|---|---|---|---|
| | Melt | GRADEX | GRADEX | GRADEX | GRADEX | GRADEX | GRADEX | GRADEX | GRADEX | Bulk | Particle |
| Sample | Flow Rate | Fines | 10 Mesh | 18 Mesh | 35 Mesh | 60 Mesh | 120 Mesh | 200 Mesh | Pan | Density | Size |
| No. | (g/10 min) | (wt %) | (wt %) | (wt %) | (wt %) | (wt %) | (wt %) | (wt %) | (wt %) | (g/cm³) | (mm) |
| 1 | 3477 | 9.7 | 0.0 | 0.2 | 13.1 | 45.8 | 31.1 | 7.6 | 2.1 | 0.35 | 0.32 |
| 2 | 919 | 4.5 | 0.0 | 0.1 | 19.6 | 52.5 | 23.4 | 3.5 | 0.9 | 0.35 | 0.37 |
| 3 | 1590 | 5.0 | 0.0 | 0.0 | 20.2 | 51.0 | 23.8 | 3.7 | 1.3 | 0.35 | 0.37 |
| 4 | 1532 | 4.3 | 0.0 | 0.1 | 20.4 | 51.6 | 23.5 | 3.5 | 0.9 | 0.35 | 0.37 |
| 5 | 1411 | 5.5 | 0.0 | 0.1 | 19.3 | 52.6 | 22.5 | 3.7 | 1.8 | 0.35 | 0.37 |
| 6 | 1938 | 5.4 | 0.0 | 0.0 | 19.1 | 52.6 | 22.9 | 3.6 | 1.8 | 0.35 | 0.37 |
| 7 | 2461 | 6.3 | 0.0 | 0.0 | 3.3 | 63.3 | 27.1 | 4.4 | 1.9 | 0.35 | 0.30 |
| 8 | 2560 | 6.1 | 0.0 | 0.0 | 1.5 | 63.2 | 29.3 | 4.5 | 1.6 | 0.34 | 0.29 |
| 9 | 2782 | 5.9 | 0.0 | 0.0 | 1.6 | 63.3 | 29.1 | 4.3 | 1.6 | 0.34 | 0.29 |
| 10 | 2613 | 5.9 | 0.0 | 0.0 | 1.6 | 63.3 | 29. | 4.3 | 1.6 | 0.34 | 0.29 |
| 11 | 2307 | 6.7 | 0.0 | 0.0 | 1.9 | 60.7 | 30.7 | 5.1 | 1.6 | 0.35 | 0.29 |
| 12 | 2511 | 7.2 | 0.0 | 0.0 | 1.2 | 62.3 | 29.3 | 5.2 | 1.9 | 0.36 | 0.28 |
| 13 | 1008 | 5.8 | 0.0 | 0.1 | 17.0 | 63.3 | 13.7 | 2.5 | 3.3 | 0.34 | 0.37 |
| 14 | 1514 | 4.0 | 0.0 | 0.1 | 22.9 | 60.5 | 12.5 | 2.3 | 1.7 | 0.34 | 0.40 |
| 15 | 1108 | 4.9 | 0.0 | 0.1 | 49.2 | 38.5 | 7.4 | 2.5 | 2.4 | 0.36 | 0.50 |
| 16 | 1509 | 3.9 | 0.0 | 0.1 | 38.9 | 49.5 | 7.6 | 1.9 | 2.0 | 0.36 | 0.47 |
| 17 | 1204 | 3.5 | 0.1 | 0.1 | 34.6 | 54.1 | 7.6 | 1.9 | 1.6 | 0.36 | 0.45 |
| 18 | 2066 | 6.1 | 0.0 | 0.1 | 11.4 | 68.0 | 14.4 | 2.8 | 3.3 | 0.36 | 0.35 |

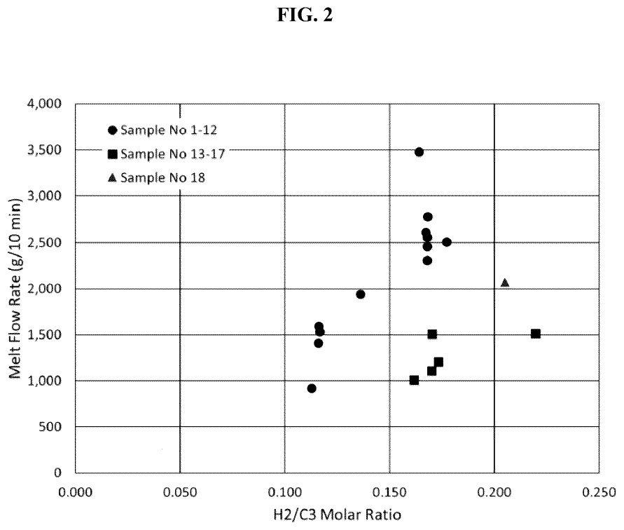

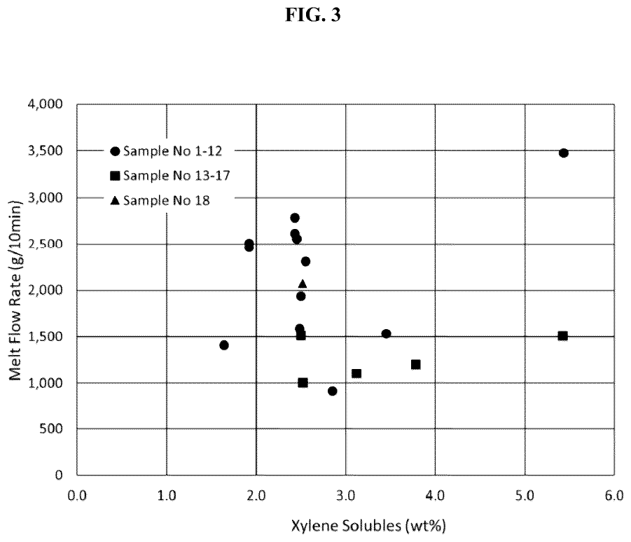

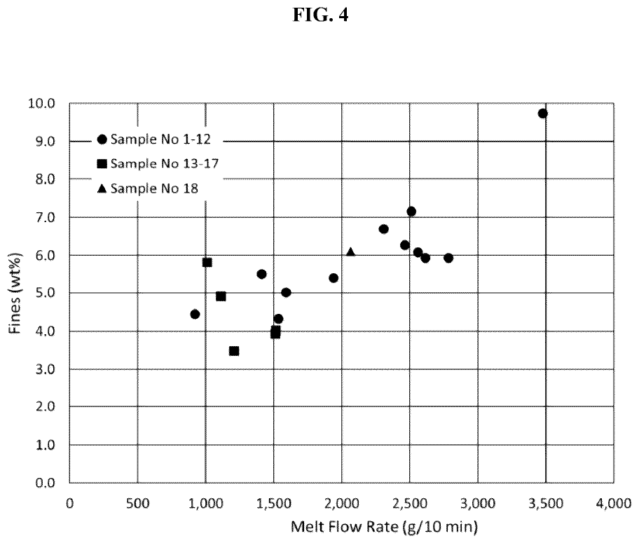

As shown above, all of the samples had a melt flow rate of greater than 900 g/10 min with the highest melt flow being 8,152 g/10 min. The results are also illustrated in FIGS. 2 through 4. As shown in FIG. 4, the amount of fines produced during the process was relatively low.

As shown above, higher reactor temperature is beneficial. Sample 18 was produced at 80° C. whiles samples 1-17 were produced at 72° C. Comparing examples 14 and 18, the molecular weight distribution (MWD) and Mw are both lower when reactor temperature is higher while the melt flow rate is higher yet the hydrogen ratio is kept at about the same.

Further samples were made at higher reactor temperature with Catalyst A, as shown in the table below.

TABLE 5

| | | | TEAl/ | | | |
|---|---|---|---|---|---|---|
| | | | External | Melt | Xylene | |
| | Reactor | | Donor | Flow | Solubles - | |
| | Temper- | H2/C3 | Molar | Rate | Wet | Catalyst |
| Sample | ature | Molar | Feed | (g/10 | Method | Productivity |
| No. | (° C.) | Ratio | Ratio | min) | (wt %) | (kg/kg) |
| 19 | 80 | 0.109 | 9.17 | 1600 | 3.0 | 48,571 |
| 20 | 90 | 0.098 | 9.21 | 1754 | 3.1 | 56,667 |
| 21 | 90 | 0.198 | 9.86 | 8152 | 4.6 | 60,714 |

Material made with both catalyst A and B was evaluated on a melt blown line to produce fibers with average fiber diameters as shown in Table 6:

TABLE 6

| | | Melt Flow Rate | Melt Blown Fiber Avg. |
|---|---|---|---|
| Sample No. | Catalyst | (g/10 min) | Diameter (micron) |
| 3 | A | 1590 | 3.2 |
| 14 | B | 1514 | 2.4 |

### Example 2. Resin Properties

All reactor grade powders were pelletized with a Brabender single screw extruder with processing temperature at 200° C. and 60 RPM. The additive package for all of the powders in accordance to this disclosure during pelletization was the same: 400 ppm Irganox® 1010, 800 ppm Irgafos® 168 & 180 ppm ZnO.

Comparative #4 is a commercial polypropylene grade intended for meltblown applications that is produced using a Ziegler Natta catalyst and is peroxide cracked to achieve a high MFR. Comparative #3 is a polypropylene resin produced with a metallocene catalyst and is not peroxide cracked.

Inventive #1 and #2 were produced using Catalyst B, which is LYNX 1010 catalyst commercially available from the W.R. Grace and Company. The LYNX 1010 catalyst includes a solid catalyst component containing a magnesium moiety, a titanium moiety, an epoxy compound, and an organosilicon compound. The LYNX 1010 catalyst includes a phthalate compound as an internal electron donor.

Comparative #1 and #2 were produced using Catalyst A, a similar solid catalyst component but using a non-phthalate substituted phenylene diester internal electron donor.

| | Inventive | Inventive | Comparative | Comparative | Comparative | Comparative |
|---|---|---|---|---|---|---|
| Examples | #1 | #2 | #1 | #2 | #3 | #4 |
| MFR | 1301 | 1818 | 1541 | 1803 | 1533 | 1698 |
| (g/10 min) | | | | | | |
| XS (wt %) | 3.1 | 2.5 | 2.4 | 1.8 | 2.0 | 4.0 |
| Tm (° C.) | 159 | 158 | 158 | 158 | 148 | 157 |
| Mn (g/mol) | 7800 | 7700 | 10200 | 9600 | 20300 | 14000 |
| Mw (g/mol) | 68800 | 60700 | 69900 | 67300 | 64700 | 56300 |
| Mz (g/mol) | 214300 | 179300 | 291300 | 291700 | 154400 | 116700 |
| Mz + 1 | 463100 | 379600 | 768700 | 784600 | 358500 | 194400 |
| (g/mol) | | | | | | |
| Mw/Mn | 8.8 | 7.9 | 6.9 | 7.0 | 3.2 | 4.0 |
| Mz + 1/Mw | 6.7 | 6.3 | 11.0 | 11.7 | 5.5 | 3.5 |

Note:
The properties of Comparative #3 were tested on powders, while all other samples were tested in pellets. The XS content of Comparative #3 was tested by wet method, while all other samples were tested by XS Viscotek method.

MB fabrics properties: The MB fabrics were produced on the lab-scale LBRD extrusion line (⅝″ extruders with L/D of 24:1) with a MB head (die with 23 holes). All the samples were produced at the same fabrication condition. Processing temperature was kept at 230° C., and the throughput was kept at 0.6 ghm (belt speed=3.5 m/min). Air pressure at 5 psi and 259° C. were provided for quenching. The fabrics basis weight was kept at 20 grams. No calendaring or bonding was applied on the MB fabrics, and the fabrics were collected after rolling with low pressure at room temperature.

The average fiber size (or fiber diameter) and size distribution in the MB fabrics are the most important factors for the MB fabrics. In general, smaller fiber size give rise to softer fabrics, better liquid barrier resistance, and lower air permeability. As described in the Testing Procedures Section, the average fiber diameters was achieved by the average of 50 measurements from five SEM images in different locations on the fabrics.

| | Inventive | Inventive | Comparative | Comparative | Comparative | Comparative |
|---|---|---|---|---|---|---|
| Examples | #1 | #2 | #1 | #2 | #3 | #4 |
| Average fiber | 2.4 | 2.1 | 3.2 | 2.6 | 1.5 | 1.2 |
| diameter (um) | | | | | | |
| Standard | 0.5 | 0.7 | 0.7 | 0.9 | 0.4 | 0.3 |
| deviation (um) | | | | | | |

As shown in the above table, under the same MB fabrication conditions, the two MB fabrics produced with catalyst A (Comparative #1 and #2) have larger average fiber size and broader distribution than the two inventive samples. This is due to larger Mz and Mz+1 of the Comparative #1 and #2, which give rise to more long-chain molecule entanglements and more fiber breakage during attenuation. The fiber breakage prohibits the further attenuation of MB fibers and leads to fibers with larger diameters.

SMS fabrics properties: The SMS multilayer fabrics (SBNW-MB-SBNW) were off-line calendared from the non-calendared MB fabrics and the SBNW fabrics produced on the NRX-12 SBNW equipment. Six different MB fabrics were made with the 4 inventive samples and 2 comparative samples were used in the SMS fabrics. For the SBNW layer, two commercial grade SBNW pellets (X and Y) were used in different SMS fabrics. Pellets X was a cracked grade hPP resin for SBNW applications produced with CONSISTA® C602 catalyst available from W. R Grace under UNIPOL® PP technology, while Pellets Y was a 35 MFR cracked grade PP resin for SBNW application produced with unknown catalyst and process technology.

| | Pellets | XS | | | | | | | |
|---|---|---|---|---|---|---|---|---|---|
| | MFR | content | Tc | Tm | | Mw | Mn | Mz | Mz + 1 |
| Sample | (g/10 min) | (wt %) | (° C.) | (° C.) | Mw/Mn | (g/mol) | (g/mol) | (g/mol) | (g/mol) |
| X | 24 | 3.0 | 119 | 162 | 3.8 | 206300 | 54100 | 419500 | 659800 |
| Y | 36 | 1.8 | 112 | 161 | 3.4 | 171900 | 51200 | 352200 | 573500 |

All SBNW fabrics were firstly produced on the lab-scale BRD extrusion line (1.25″ extruders with L/D of 30:1) with the NRX-12 SBNW equipment, which included a SBNW spinpack with 72 holes and 0.35 mm diameter per hole. All the samples were prepared at the same fabrication condition to match with the MB fabrication process. Processing temperature was kept at 230° C., and the throughput was kept at 0.6 ghm (belt speed=3.5 m/min). The fabrics basis weight was kept at 20 gsm. The aspirator air pressure for attenuation was kept at 28 psi. After two layers of non-calendared SBNW fabrics were produced, they were immediately off-line calendared with the non-calendared MB fabrics in the sandwich structure (MB as the core layer) under the bonding temperature at 135° C. The tensile strength and the air permeability of the SMS nonwoven fabrics were determined in accordance to methods described in the Testing Procedures Section.

The machine direction (MD) tensile strength is one of the most important properties for SMS fabrics, because it affects the mechanical performance of SMS fabrics end products, such as diapers and face masks. The MD tensile strength of the SMS fabrics mainly depends on the two SBNW layers and the bonding condition between SBNW layers and MB layer. Therefore, under the same bonding temperature at 135° C. and the same SBNW layer (HT2511 or PP 3155E5), SMS fabrics produced with inventive MB layers showed similar tensile strength with comparative counterparts (the difference with average value is within 10%). The reason for the small differences between inventive grades and comparative grades in tensile strength was because the mechanical properties were determinated by the SBNW layers rather than the MB core layer in the SMS fabrics.

| SBNW layers | | | | Air Permeability, 135 C. |
|---|---|---|---|---|
| in the SMS | MB layer in the | MD tensile strength | MD elongation | bonding temp. |
| fabrics | SMS fabrics | (g/inch) | (%) | (l/m²/sec) |
| Pellet X (25 | Inventive #1 | 3300 | 26 | 73 |
| MFR cracked | Inventive #2 | 2885 | 21 | 53 |
| grade) | Comparative #1 | 3130 | 33 | 220 |
| | Comparative #2 | 3120 | 26 | 147 |
| | Comparative #3 | 3030 | 20 | 48 |
| | Comparative #4 | 2875 | 23 | 65 |
| Pellet Y (35 | Comparative #1 | 3060 | 27 | 152 |
| MFR cracked | Comparative #3 | 3580 | 33 | 47 |
| grade) | | | | |

Air permeability is another important property for SMS fabrics, because it affects the filtration efficiency of SMS fabric end products, such as industrial filters. In general, finer fibers in the MB layer give rise to smaller pore size, which contributes to the lower air permeability and high filtration efficiency. The low air permeability is usually correlated with the high hydrohead or high liquid barrier resistance, which is significant to the SMS fabric end products for medical and hygiene applications, such as diapers. The two inventive grades showed similar air permeability with Comparative #3 and #4, while the Comparative #1 and #2 had much higher air permeability. This was because of the larger average fiber diameter and larger standard deviation of Comparative #1 and #2, which was due to the high M_{z+1}/M_{w} ratio (or high M_{z} and M_{z+1}).

Furthermore, these results highlight the balance of air permeability versus the mechanical performance of the SMS fabrics of Inventive #1 & #2 (vs Comparative 3 and 4, commercial incumbents with either metallocene catalyst or cracked grade) and better than comparative 1 &2.

While certain embodiments have been illustrated and described, it should be understood that changes and modifications may be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations may be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like, include the number recited and refer to ranges which may be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1-49. (canceled)

50. A polymer composition comprising a polypropylene polymer having the following characteristics:
exhibiting a melt flow rate of greater than about 900 g/10 min;
a molecular weight distribution (Mw/Mn) of greater than 4.5;
an Mz+1/Mw ratio of less than about 8; and
a xylene soluble content of less than about 4.0% by weight.

51. The polymer composition according to claim 50, wherein the polypropylene polymer exhibits a melt flow rate of greater than about 1300 g/10 min.

52. The polymer composition according to claim 50, wherein the polypropylene polymer has an M_{w}/Mₙ of greater than about 6 and/or an M_{z+1}/M_{w} ratio of less than about 7.

53. The polymer composition according to claim 50, wherein the polypropylene polymer has a xylene soluble content of from about 1.5% by weight to about 4% by weight.

54. The polymer composition according to claim 50, wherein the polypropylene polymer exhibits a melting temperature of greater than about 155° C.

55. The polymer composition according to claim 50, wherein the polypropylene polymer has a weight averaged molecular weight of less than about 80,000 g/mol and/or a number averaged molecular weight of less than about 8,500 g/mol.

56. The polymer composition according to claim 50, wherein the polypropylene polymer has been catalyzed in the presence of a Ziegler-Natta catalyst comprising an internal electron donor, the internal electron donor comprising a substituted phenylene diester or a phthalate compound.

57. The polymer composition according to claim 50, wherein the polypropylene polymer has been catalyzed in the presence of a Ziegler-Natta catalyst, the Ziegler-Natta catalyst comprising a solid catalyst component, a selectively control agent, and optionally an activity limiting agent, the solid catalyst component comprising a magnesium moiety, a titanium moiety, and an internal electron donor.

58. The polymer composition according to claim 57, wherein the solid catalyst component further comprises an organosilicon compound and an epoxy compound.

59. The polymer composition according to claim 57, wherein the selectively control agent comprises an organosilicon compound.

60. The polymer composition according to claim 50, wherein the polypropylene polymer comprises a processing aid combined with at least one other polymer exhibiting a lower melt flow rate, the polypropylene polymer being contained in the composition in an amount less than about 50% by weight.

61. The polymer composition according to claim 50, wherein the polypropylene polymer does not comprise any peroxides.

62. A meltblown web comprised of nonwoven, meltblown fibers, the meltblown fibers being made from the polymer composition of claim 50.

63. A meltblown fiber made from a polymer composition according to claim 50, the meltblown fiber having a diameter of less than about 5 microns.

64. A nonwoven web comprising a multi-layer structure comprising one or more meltblown layers comprising a meltblown fiber according to claim 63.

65. The nonwoven web according to claim 64, further comprising two or more spunbound layers comprising a spunbound fiber.

66. The nonwoven web according to claim 65, wherein the spunbound fiber is prepared from a polymer composition comprising a polypropylene polymer having one or more of the following characteristics:
exhibiting a melt flow rate of from about 20 g/10 min to about 70 g/10 min;
having a molecular weight distribution (Mw/Mn) of less than about 4; and
having a xylene soluble content of from about 1.5% by weight to about 4% by weight.

67. The nonwoven web according to claim 66, wherein the polypropylene polymer has an M_{w}/Mₙ of from about 3.0 to about 4.0, a weight averaged molecular weight of less than about 300,000 g/mol, and/or a number averaged molecular weight of less than about 60,000 g/mol.

68. The nonwoven web according to claim 65, wherein the nonwoven web comprises two or more spunblown layers.

69. The nonwoven web according to claim 66, wherein the nonwoven web has a multilayer structure comprising a first spunbound layer, a meltblown layer, and a second spunbound layer.
